(19) United States
(12) Patent Application Publication
(10) Pub. No.: US 2014/0051454 A1
(43) Pub. Date: Feb. 20, 2014

(54) REDUCING DATA TRANSFER LATENCY CAUSED BY STATE TRANSITIONS IN MOBILE NETWORKS

(71) Applicants: Jeffrey William Wirtanen, Kanata (CA); Muhammad Khaledul Islam, Kanata (CA)

(72) Inventors: Jeffrey William Wirtanen, Kanata (CA); Muhammad Khaledul Islam, Kanata (CA)

(21) Appl. No.: 13/587,608

(22) Filed: Aug. 16, 2012

(51) Int. Cl. H04W 72/00; H04W 24/10

(52) U.S. Cl. 455/452.1

(57) ABSTRACT

Example methods, apparatus and articles of manufacture for reducing data transfer latency caused by state transitions in mobile networks are disclosed. An example method for a wireless device disclosed herein comprises, while operating in a first state having fewer available radio resources than would be available in a second state, setting an indicator if the wireless device determines that a large amount of data is expected to be transferred, and sending a message including the indicator to a network.

### FIELD OF THE DISCLOSURE

This disclosure relates generally to mobile networks and, more particularly, to reducing data transfer latency caused by state transitions in mobile networks.

### BACKGROUND

Universal Mobile Telecommunication System (UMTS) radio access networks support different radio resource control (RRC) states corresponding to different degrees of connectivity between the network and the mobile stations (also referred to as user equipment or UEs) operating in the network. A UMTS radio access network typically controls when a mobile station is permitted to transition from one RRC state to a different RRC state based on a variety of information available to the network. For example, the network may configure the mobile station to transition from a Cell_FACH state having limited connectivity to a Cell_DCH state having more connectivity based on the amount of data the network determines is ready to be transferred from or to the mobile station.

### BRIEF DESCRIPTION OF THE DRAWINGS

FIG. 1 is block diagram of an example UMTS network in which data transfer latency caused by state transitions can be reduced in accordance with the examples disclosed herein.

FIG. 2 is a state diagram illustrating example state transitions supported by an example UMTS radio access network included in the UMTS network of FIG. 1.

FIGS. 3-5 are event sequence diagrams illustrating example data transfer latencies that may be caused by state transitions in a UMTS radio access network in which data transfer latency caused by state transitions is not reduced in accordance with the examples disclosed herein.

FIG. 6 is a block diagram illustrating example protocol layers implemented by an example mobile station for use in the UMTS network of FIG. 1.

FIGS. 7-9 are event sequence diagrams illustrating further example data transfer latencies that may be caused by state transitions in a UMTS radio access network in which data transfer latency caused by state transitions is not reduced in accordance with the examples disclosed herein.

FIG. 10 is a block diagram of an example state transition processor that can be used to implement an example mobile station for use in the UMTS radio access network of FIG. 1.

FIG. 11 is a block diagram of an example state configuration processor that can be used to implement an example network element for use in the UMTS radio access network of FIG. 1.

FIGS. 12 and 12A-D are flowcharts representative of example processes that may be performed by the state transition processor of the mobile station of FIG. 10 to implement a first family of example solutions to reduce data transfer latency caused by state transitions in the UMTS radio access network of FIG. 1.

FIGS. 12E-F are event sequence diagrams illustrating example implementations of the processes of FIGS. 12 and 12A-D.

FIG. 13 is a flowchart representative of an example process that may be performed by the state transition processor of the mobile station of FIG. 10 to implement a second family of example solutions to reduce data transfer latency caused by state transitions in the UMTS radio access network of FIG. 1.

FIGS. 14-15 are event sequence diagrams illustrating example implementations of the process of FIG. 13.

FIG. 16 is a flowchart representative of an example process that may be performed by the state transition processor of the mobile station of FIG. 10 to implement a third family of example solutions to reduce data transfer latency caused by state transitions in the UMTS radio access network of FIG. 1.

FIG. 17 is an event sequence diagram illustrating an example implementation of the process of FIG. 16.

FIG. 18 is a block diagram of an example processing system that may execute example machine readable instructions used to implement some or all of the processes of FIGS. 12, 12A-D, 13 and/or 16 to implement the state transition processor of the mobile station of FIG. 10, the state configuration processor of the network element of FIG. 11, and/or the UMTS radio access network of FIG. 1.

Wherever possible, the same reference numbers will be used throughout the drawing(s) and accompanying written description to refer to the same or like elements.

### DETAILED DESCRIPTION

Example methods, apparatus and articles of manufacture (e.g., storage media) for reducing data transfer latency caused by state transitions in mobile networks are disclosed herein. In a first family of example methods disclosed herein, the method begins with a mobile station operating in a first state (e.g., such as an RRC Cell_FACH state, an RRC Cell_PCH state, an RRC URA_PCH state or an RRC idle state) having fewer available radio resources than would be available in a second state (e.g., such as an RRC Cell_DCH state). While the mobile station is operating in the first state that has fewer available radio resources than would be available in the second state, the disclosed example method includes setting an indicator when the mobile station determines that a large amount of data is expected to be transferred. The disclosed example method further includes the mobile station sending a message including the indicator to a network, such as a UMTS radio access network.

In some disclosed examples of the first method family, the message sent by the mobile station to the network includes a CELL UPDATE message, and the indicator includes a traffic volume indicator (TVI) information element (IE) to be included in the CELL UPDATE message. In some disclosed examples, the message sent by the mobile station to the network includes the CELL UPDATE message, and the indicator includes an indicator IE, different from the TVI, to be included in the CELL UPDATE message. In some disclosed examples, the message sent by the mobile station to the network includes a measurement report, and the indicator includes the TVI, which is to be included in the measurement report. In some disclosed examples, the message sent by the mobile station to the network includes the measurement report, and the indicator is an indicator IE, different from the TVI, which is to be included in the measurement report.

Some disclosed examples of the first method family further include determining that a large amount of data is expected to be transferred based on, for example, determining that an amount of uplink data to be transmitted by the mobile station exceeds a threshold, receiving an upper layer indication, etc., or any combination(s) thereof. Accordingly, in some disclosed examples, the indicator can be set when the mobile station determines that a large amount of data is expected to be transferred (e.g., via an upper layer indication), although a radio link control (RLC) buffer occupancy at the mobile station is not larger than a traffic volume measurement threshold.

As described in greater detail below, the large amount of data expected to be transferred can correspond to uplink data to be transmitted by the mobile station, downlink data to be received by the mobile station, or both. Accordingly, some disclosed examples of the first method family further include setting a first indicator when the mobile station determines that a large amount of data is expected to be transferred, setting a second indicator to indicate a transmission direction for the large amount of data expected to be transferred, and including the first indicator and the second indicator in the message to be sent to the network.

In a second family of example methods disclosed herein, the method begins with a mobile station operating in a first state (e.g., such as an RRC Cell_FACH state, an RRC Cell_PCH state, an RRC URA_PCH state or an RRC idle state) having fewer available radio resources than would be available in a second state (e.g., such as an RRC Cell_DCH state). While the mobile station is operating in the first state that has fewer available radio resources than would be available in the second state, the disclosed example method includes setting a traffic volume indicator when the mobile station determines that an RLC buffer occupancy is larger than a traffic volume measurement threshold. The disclosed example method further includes sending the traffic volume indicator to a network, such as a UMTS radio access network, in a transmitted message other than a CELL UPDATE message having uplink data transmission as an update cause.

In some disclosed examples of the second method family, the transmitted message is the CELL UPDATE message, and the update cause includes one or more of radio link failure, cell reselection or radio RLC unrecoverable error. In some disclosed examples, the transmitted message comprises one or more of a RADIO BEARER RECONFIGURATION COMPLETE message, a RADIO BEARER SETUP COMPLETE message, a RADIO BEARER RELEASE COMPLETE message, a TRANSPORT CHANNEL RECONFIGURATION COMPLETE message, or a PHYSICAL CHANNEL RECONFIGURATION COMPLETE message.

Some disclosed examples of the second method family further include obtaining the traffic volume measurement threshold while operating in an RRC Cell_FACH state prior to operating in the first state. In such examples, the method can further include storing the traffic volume threshold for use when the mobile station is operating in the first state.

In a third family of example methods disclosed herein, the method begins with a mobile station operating in a first state (e.g., such as an RRC Cell_DCH state). While the mobile station is operating in the first state, the disclosed example method includes receiving a message that is to cause the mobile station to transition to a second state (e.g., such as an RRC Cell_FACH state, an RRC Cell_PCH state, an RRC URA_PCH state or an RRC idle state) having fewer available radio resources than are available in the first state. The disclosed example method further includes rejecting the message when the mobile station has pending uplink data to send to a network, such as a UMTS radio access network.

In some disclosed examples of the third method family, the received message comprises one or more of a RADIO BEARER RECONFIGURATION message, a RADIO BEARER SETUP message, a RADIO BEARER RELEASE message, a TRANSPORT CHANNEL RECONFIGURATION message, or a PHYSICAL CHANNEL RECONFIGURATION message. In some disclosed examples, the received message includes an indication that rejection for uplink data is allowed. In some disclosed examples, rejecting the message includes sending a failure response to the network in which the failure response includes pending uplink data as a failure cause.

Some disclosed examples of the third method family further include rejecting the received message when an amount of the pending uplink data to send to the network is larger than a traffic volume measurement threshold. In such examples, the method can further include not rejecting (or, in other words, accepting) the message when the amount of the pending uplink data to send to the network is not larger than (or, in other words, is less than or equal to) the traffic volume measurement threshold.

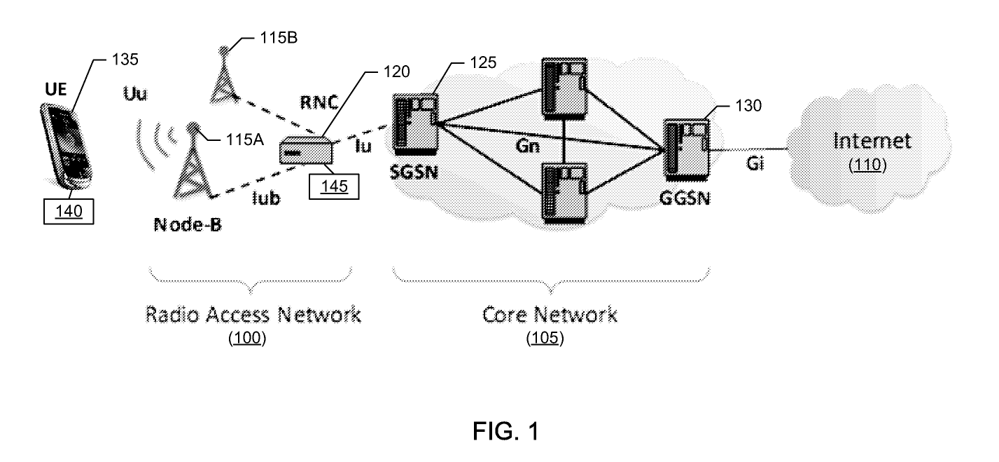

As described in greater detail below, the foregoing example methods, as well as the further example methods, apparatus and articles of manufacture disclosed herein, can reduce data transfer latency caused by state transitions in mobile networks. An example of such a UMTS radio access network (RAN) 100 in which data transfer latency caused by state transitions can be reduced in accordance with the examples disclosed herein is illustrated in FIG. 1. In the illustrated example of FIG. 1, the UMTS radio access network 100 is connected to an example general packet radio service (GPRS) core network (CN) 105, which is further coupled to an external network 110, such as the Internet. The UMTS radio access network 100 of the illustrated example is implemented using network elements, or nodes, including one or more example basestations 115A-B (also referred to as Node-Bs 115A-B), and an example radio network controller (RNC) 120. The CN 105 of the illustrated example is implemented using network elements, or nodes, including an example serving GPRS support node (SGSN) 125 and an example gateway GPRS support node (GGSN) 130. The interfaces between these nodes are also shown in FIG. 1.

The UMTS radio access network 100 (or UTRAN 100) of FIG. 1 provides network connectivity for an example mobile station 135, also referred to as user equipment or UE 135. The mobile station 135 can be implemented by any type of mobile station or user endpoint equipment, such as a smartphone, a mobile telephone device that is portable, a mobile telephone device implementing a stationary telephone, a personal digital assistant (PDA), etc., or, for example, any other type of wireless device. Although one mobile station 135 is illustrated in FIG. 1, the example UMTS radio access network 100 can support any number of mobile stations 135 (as well as any number of basestations 115A-B and/or RNCs 120). In the illustrated example of FIG. 1, the mobile station 135 includes an example state transition processor 140. In some examples, one or more of the RNCs 120 of the UMTS radio access network 100 also include an example state configuration processor 145. As further described below, the state transition processor 140 included in the mobile station 135, and the state configuration processor 145 included in the RNC 120, implement one or more processes that separately or in combination can reduce data transfer latency caused by state transitions in the UMTS radio access network 100.

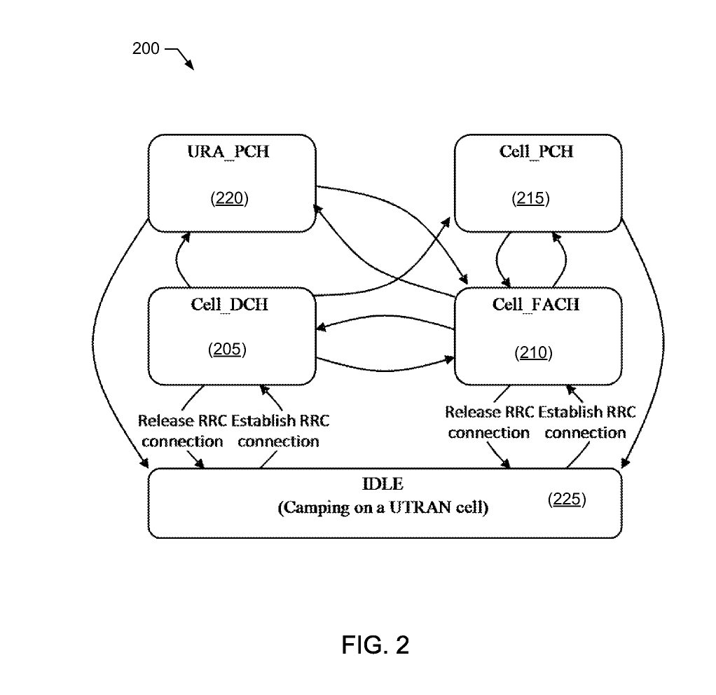

The mobile station 135 and the UMTS radio access network 100 support different radio resource control (RRC) states to vary the degree of connectivity between the mobile station 135 and the network 100. An example RRC state diagram 200 depicting the RRC states and state transitions supported by the mobile station 135 and the UMTS radio access network 100 of FIG. 1 is illustrated in FIG. 2. The RRC state diagram 200 includes the Cell_DCH state 205, the Cell_FACH state 210, the Cell_PCH state 215 and the URA_PCH state 220, all of which are different states within a connected mode of operation between the mobile station 135 and the network 100. This connected mode may be referred to as RRC connected mode and in this mode an RRC connection exists between the mobile station 135 and the radio access network 100. The RRC state diagram 200 also includes an idle state 225, which corresponds to an idle mode of operation between the mobile station 135 and the network 100. RRC state control according to the states and transitions depicted in the RRC state diagram 200 of FIG. 2 may be implemented by a state machine engine operating within, for example, the RNC 120 and/or mobile station 135. An example of such a state machine is described in Third Generation Partnership Project (3GPP) Technical Specification (TS) 25.331, “Radio Resource Control (RRC); Protocol specification,” Version 10.5.0 (September 2011), which is incorporated herein by reference in its entirety.

In the Cell_DCH state 205, full user-plane connectivity is established between the mobile station 135 and the core network 105 (via the radio access network 100). Associated bearers are established between the mobile station 135 and the network nodes implementing the connection path (e.g., such as the Uu, Iub, Iu, Gn, Gi interfaces illustrated in FIG. 1). While in the Cell_DCH state 205, the mobile station 135 can access the dedicated or shared radio resources allocated by the radio access network 100. Also, the location of the mobile station 135 is known to the cell level by the radio access network 100, and the network 100 is in control of cell-level mobility (e.g., via network-controlled handover). Device power consumption in the Cell_DCH state 205 can be relatively high.

In the Cell_FACH state 210, a lower level of user-plane connectivity between the mobile station 135 and the core network 105 (via the radio access network 100) is possible using limited amounts of shared or common radio resources. The associated bearers remain established between the mobile station 135 and the network nodes implementing the connection path. While in the Cell_FACH state 210, the location of the mobile station 135 is known to the cell level, but the mobile station 135 is able to autonomously control its cell-level mobility (e.g., via cell reselection). A discontinuous receive (DRX) pattern may be employed to enable further power savings in the mobile station 135. If the Enhanced Cell_FACH feature (which was added in Release 7 of the 3GPP UMTS specifications) is supported in the radio access network 100, then larger amounts of data may be transferred between the network 100 and the mobile station 135 while the mobile station 135 is operating in the Cell_FACH state 210.

In the Cell_PCH state 215, the necessary bearers for user-plane communications through the radio access network 100 remain established, but no radio resources are available for data transfer. As such, there is no data activity in the Cell_PCH state 215 and user-plane communication requires a transition to either the Cell_FACH state 210 or the Cell_DCH 205. In the Cell_PCH state 215, the mobile station 135 periodically or otherwise intermittently receives a paging channel (e.g., according to a known DRX cycle) that may contain notification(s) to cause the mobile station 135 to transition to a more active state, thereby enabling the mobile station 135 to conserve power while in this less active state. While in the Cell_PCH state 215, the location of the mobile station 135 is known by the radio access network 100 to the cell level, and mobility is autonomously controlled by the mobile station 135. If the Enhanced Cell_FACH feature is supported in the radio access network 100, then the Cell_PCH behavior described above is slightly modified. For example, the mobile station 135 does not need to be paged to cause it to transition into Cell_FACH state before any downlink data and/or signaling can be delivered to the mobile station 135. Instead, the downlink data and/or signaling can be sent directly to the mobile station 135 while it is in operating the Cell_PCH state 215, and the reception of downlink data and/or signaling causes the mobile station 135 to transition into the Cell_FACH state 210.

The URA_PCH state 220 is similar to the Cell_PCH state 215 except that, for example, the location of the mobile station 135 is known by the radio access network 100 to the level of a group of cells, instead of down to the level of a single cell as in the Cell_PCH state 215. The group of cells is referred to as a UTRAN registration area (URA). While in the URA_PCH state 220, mobility remains autonomously controlled by the mobile station 135. In at least some examples, significant power savings (in addition to those achievable in the Cell_PCH state 215) are possible in the URA_PCH state 220 because the mobile station 135 is to inform the network 100 of its new location when the mobile station 135 enters a new UTRAN registration area, rather than providing a cell update each time the mobile station 135 enters a new cell, as is required in the Cell_PCH state 215.

In the idle state 225, user-plane connectivity is not required. No radio resources are assigned to the mobile station 135 and a DRX pattern is typically used to conserve power. User-plane connectivity between the mobile station 135, the radio access network 100 and the core network 105 is not required. While operating in the idle state 225, the mobile station 135 retains an attachment context with the core network 105 to, for example, facilitate always-on connectivity, such that the mobile station 135 is reachable and its Internet protocol (IP) address is preserved, even while in idle mode. Also, the core network 105 tracks the location of the mobile station 135 to a routing area level. For a mobile station 135 in the idle state 225, initiation of user-plane communication requires establishment of the necessary radio and access bearers and a transition to either the Cell_FACH 210 or the Cell_DCH state 205.

A summary of at least some of the attributes associated with the RRC Cell_DCH state 205, the RRC Cell_FACH state 210, the RRC Cell_PCH state 215, the RRC URA_PCH state 220 and the RRC idle state 225 is provided in Table 1.

TABLE 1

| | | Core Network | | | | |
|---|---|---|---|---|---|---|
| | Radio | Bearers | Radio | | | |
| UMTS RRC | Bearers | Established (Gn, | Resources | Location | Mobility | |
| State | Established | Gi) | Available | Accuracy | Control | DRX |
| Cell_DCH | Yes | Yes | Yes | Cell | Network | Typically |
| | | | (extensive) | | | no DRX |
| Cell_FACH | Yes | Yes | Yes | Cell | UE | Short |
| | | | (limited) | | | sleep |
| Cell_PCH | Yes | Yes | No | Cell | UE | Long |
| | | | | | | sleep |
| URA_PCH | Yes | Yes | No | UTRAN | UE | Long |
| | | | | Registration | | sleep |
| | | | | Area | | |
| Idle | No | Yes | No | Routing Area | UE | Long |
| | | | | | | sleep |

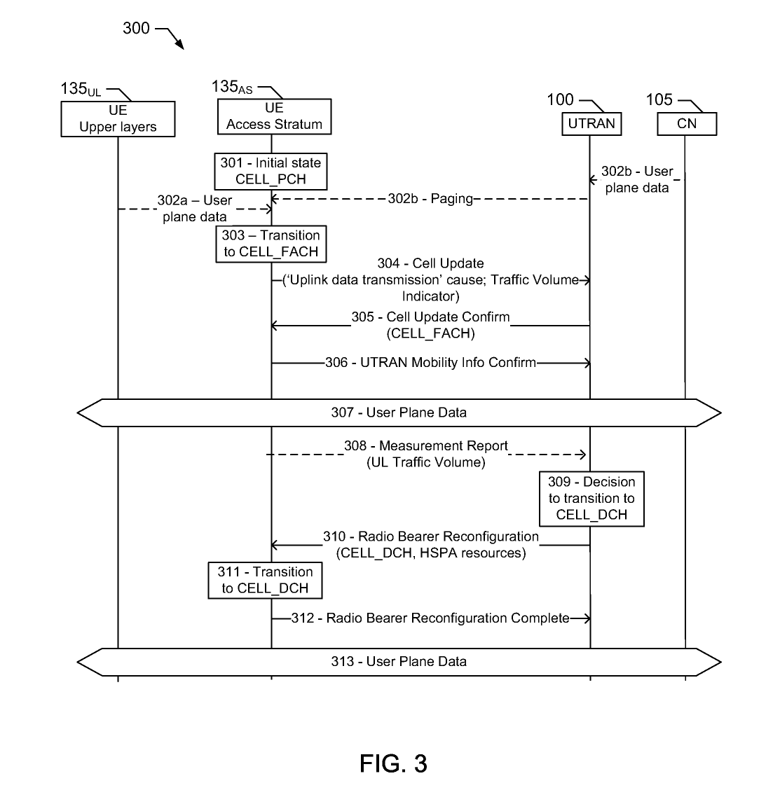

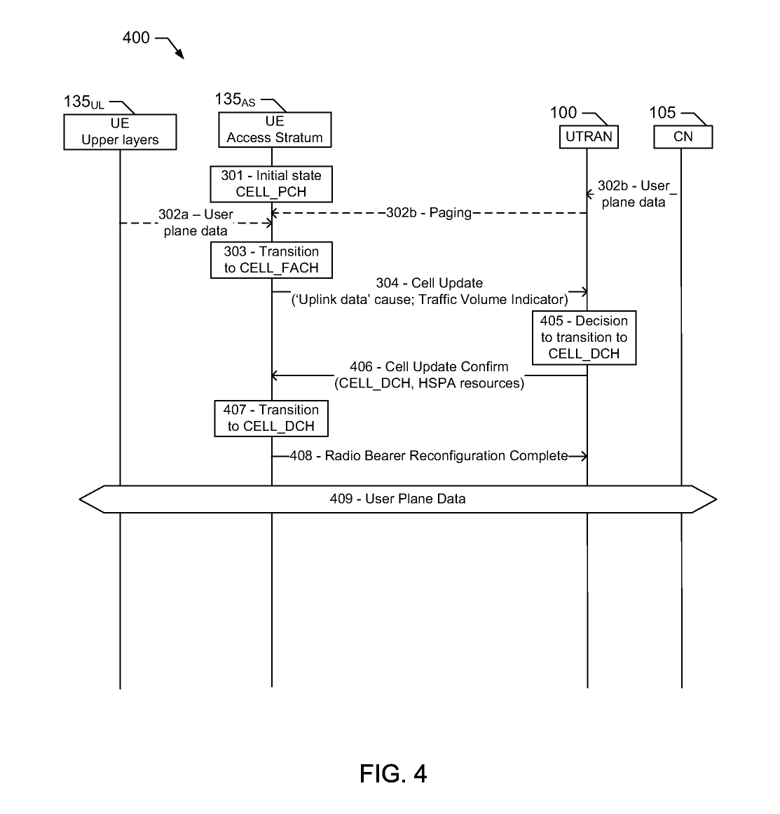

As mentioned above, in the illustrated example of FIG. 1, the state transition processor 140 included in the mobile station 135 and/or the state configuration processor 145 included in the RNC 120 implement one or more processes that separately or in combination can reduce data transfer latency caused by RRC state transitions in the UMTS radio access network 100. FIGS. 3 and 4 depict example event sequence diagrams illustrating possible data transfer latencies associated with such RRC state transitions. For example, when the mobile station 135 is in the Cell_PCH state 215 or the URA_PCH state 220 and data activity is to be resumed, the mobile station 135 is to transition into one of the RRC states where data transfer is possible, that is, into the Cell_FACH state 210 or the Cell_DCH state 205. FIGS. 3 and 4 illustrate two example event sequence diagrams 300 and 400 depicting the operation of and the messages exchanged among the UMTS radio access network (UTRAN) 100, the core network (CN) 105 and the mobile station 135 for the resumption of data activity from the Cell_PCH state 215 or the URA_PCH state 220. In the illustrated examples of FIGS. 3 and 4, the mobile station 135 and the UTRAN 100 are assumed to be compliant with prior 3GPP UMTS specifications and, thus, do not include the state transition processor 140 and/or the state configuration processor 145 to reduce data transfer latency caused by RRC state transitions as disclosed herein.

In the example event sequence diagrams 300 and 400 of FIGS. 3 and 4, operation of and messaging in the access stratum (AS) (labeled as 135_{AS} in the figures) and upper layers (labeled as 135_{UL} in the figures) of the mobile station 135 are depicted. In the illustrated example of FIG. 1, the signaling that delivers telecommunication services is typically implemented as layers of protocols. For each protocol layer, peer entities within the mobile station 135 and the network (e.g., the UTRAN 100, the CN 105 and the external network 110) intercommunicate at their respective layer and provide services to their respective upper layer.

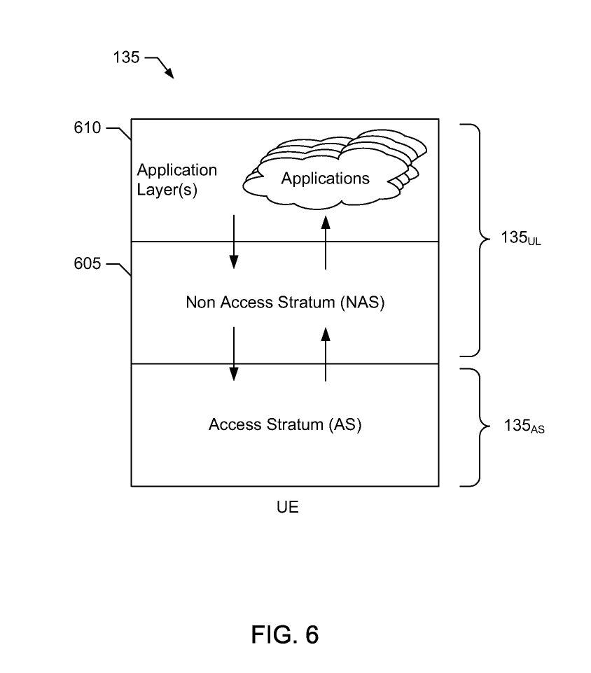

For example, to operate in the UTRAN 100 of FIG. 1, and/or other 3GPP-compliant networks, such as a 3GPP Long Term Evolution (LTE) network, the example mobile station 135 may implement the three protocol layer depicted in FIG. 6. With reference to FIG. 6, the access stratum 135_{AS} includes constituent protocols layers that are used for communication between the mobile station 135 and the radio access network 100. As such, the access stratum 135_{AS} may include the physical layer, medium access control (MAC) layer, radio link control (RLC) layer, packet data convergence protocol (PDCP) layer, RRC layer, etc. In the example of FIG. 6, the upper layers 135_{UL} include the non-access stratum 605 and the application layer(s) 610. The non-access stratum (NAS) 605 includes constituent protocols layers that are used for communication between the mobile station 135 and the core network 105. As such, the non-access stratum 605 may include the mobility management layer, the session management layer, the call control layer, etc. The application layer(s) 610 may include one or more applications that make use of the services provided by the NAS 605 and AS 135_{AS} below.

Turning to FIG. 3, and with the foregoing in mind, the event sequence diagram 300 shows an example sequence of events that may occur when the mobile station 135 is initially in the Cell_PCH state 215 (or the URA_PCH state 220) with no user plane data activity, and then user plane data activity is to be resumed. As such, at event 301, the mobile station 135 is initially in the Cell_PCH state 215. (Note that a similar sequence of events could occur in the case when the mobile station 135 is initially in the URA_PCH state 220.) Events 302a/b correspond to user plane data activity being resumed. This resumption of data activity may be mobile originated, for example, due to an application in the mobile station 135 starting to generate uplink data, which is depicted as event 302a. Alternatively, this resumption of data activity may be mobile terminated, which corresponds to the events collectively labeled as event 302b, in which case downlink data arrives in the UTRAN 100 and the UTRAN 100 then sends a paging message to the mobile station 135. In either case, at event 303, the mobile station 135 transitions from the Cell_PCH state 215 into the Cell_FACH state 210.

At event 304, the mobile station 135 sends a CELL UPDATE message to the UTRAN 100. In the illustrated example, the CELL UPDATE message contains a cause value set to ‘uplink data transmission’ in the mobile originated case, or set to ‘paging response’ in the mobile terminated case. In addition, in the mobile originated case, the message could contain a traffic volume indicator if the inclusion of the indicator has been configured by the UTRAN 100 and if the amount of uplink RLC data buffered in the mobile station 135 exceeds a threshold. More specifically, in the existing 3GPP UMTS specifications, the Traffic Volume Indicator (TVI) information element (IE) is permitted to be included in a CELL UPDATE message only if the Cell Update Cause IE included in the CELL UPDATE message is set to “Uplink Data Transmission” (see 3GPP TS 25.331 section 8.3.1.3) and the mobile station 135 is in the Cell_PCH state 215 or the URA_PCH state 220 (see 3GPP 25.331 section 8.3.1.2). The UTRAN 100 can enable inclusion of the TVI in the CELL UPDATE message by including the appropriate traffic volume measurement (TVM) information, including the appropriate threshold, within system information and/or within a measurement control message sent to the mobile station 135.

At event 305, the UTRAN 100 responds to the CELL UPDATE message with a CELL UPDATE CONFIRM message. In the illustrated example of FIG. 3, the CELL UPDATE CONFIRM message commands the mobile station 135 to remain in the Cell_FACH state 210. The UTRAN 100 can decide to have the mobile station 135 remain in the Cell_FACH state 210 based on a number of factors, such as, the amount of RLC uplink data buffered in the mobile station 135 and/or the amount of downlink RLC data for the mobile station 135 that is buffered in the RNC 120, etc. For example, the UTRAN 100 can decide to keep the mobile station 135 in the Cell_FACH state 210 if the received CELL UPDATE message did not include the TVI, which implies that the amount of RLC data buffered in the mobile station 135 is below the configured threshold.

At event 306, the mobile station 135 responds to the CELL UPDATE CONFIRM message with a UTRAN MOBILITY INFORMATION CONFIRM message. This purpose of this message is to act as a layer 3 acknowledgement message. In other examples, a different type of message, such as a RADIO BEAR RECONFIGURATION COMPLETE message or a PHYSICAL CHANNEL RECONFIGURATION COMPLETE message, may be used as the layer 3 acknowledgment.

At event 307, user plane data transfer in the uplink and/or downlink directions can now take place. Sometime later, event 308 occurs, corresponding to the mobile station 135 determining that an amount of uplink RLC data buffered in the mobile station 135 exceeds a configured threshold. When this occurs, the mobile station 135 triggers sending of a MEASUREMENT REPORT message containing traffic volume information to inform the UTRAN 100 about the amount of uplink RLC data buffered in the mobile station 135.

At event 309, the UTRAN 100 decides to move the mobile station 135 into the Cell_DCH state 205. This decision may be based on, for example, the amount of uplink RLC data buffered in the mobile station 135, whether the UTRAN 100 has received a Measurement Report message, the amount of downlink RLC data for the mobile station 135 that is buffered in the RNC 120, etc.

At event 310, the UTRAN sends a reconfiguration message, such as a RADIO BEARER RECONFIGURATION message, to command the mobile station 135 to move to the Cell_DCH state 205. If the UTRAN 100 supports high speed downlink packet access (HSDPA), which was added into Release 5 of the 3GPP UMTS specifications, and enhanced dedicated channel (E-DCH) (also referred to as high speed uplink packet access or HSUPA), which was added into Release 6 of the 3GPP UMTS specifications, then the signaled reconfiguration message may also configure the mobile station with a high speed downlink shared channel (HS-DSCH) in the downlink direction and an E-DCH channel in the uplink direction, which are generally and collectively referred to herein as high speed packet access (HSPA) resources.

At event 311, the mobile station 135 transitions from the Cell_FACH state 210 to the Cell_DCH state 205. Furthermore, at event 312, the mobile station 135 sends a reconfiguration complete message to the UTRAN 100. For example, if the reconfiguration message at event 310 was the RADIO BEARER RECONFIGURATION message, then at event 312 the reconfiguration complete message would be the RADIO BEARER RECONFIGURATION COMPLETE message. At event 313, user plane data transfer, in the uplink and/or downlink directions, can now take place using, for example, the HSPA resources that are available in the Cell_DCH state 205.

The event sequence diagram 400 of FIG. 4 shows an alternative example sequence of events that may occur when the mobile station 135 is initially in the Cell_PCH state 215 (or the URA_PCH state 22) with no user plane data activity, and then user plane data activity is to be resumed. Like events in FIGS. 3 and 4 are labeled with the same reference numerals. Accordingly, the event sequence diagram 400 of FIG. 4 begins with events 301-304, which are discussed above in connection with FIG. 3. Then, at event 405, the UTRAN 100 decides to move the mobile station 135 directly into the Cell_DCH state 205, rather than leaving the mobile station 135 in the Cell_FACH state 215 as was done in the example event sequence diagram 300 of FIG. 3. This decision to move the mobile station 135 directly into the Cell_DCH state 205 may be based on a number of factors, such the amount of uplink RLC data buffered in the mobile station 135, the amount of downlink RLC data buffered in the RNC 120 for the mobile station 135, cell loading, length of time since last data transfer, etc. For example, the UTRAN 100 can decide to move the mobile station 135 directly to the Cell_DCH state 205 if the received CELL UPDATE message included the TVI, which implies that the amount of uplink RLC data buffered in the mobile station 135 is larger than the configured threshold.

At event 406, the UTRAN 100 sends a CELL UPDATE CONFIRM message that commands the mobile station 135 to move to the Cell_DCH state 205. In some examples, this message would also configure the mobile station 135 with an HS-DSCH channel in the downlink direction and an E-DCH channel in the uplink direction.

At event 407, the mobile station 135 transitions from the Cell_FACH state 210 to the Cell_DCH state 205. Furthermore, at event 408, the mobile station 135 sends a reconfiguration complete message, such as a RADIO BEARER RECONFIGURATION COMPLETE message, to the UTRAN 100. The reconfiguration message that is sent at event 408 depends on, for example, the configuration parameters that were included the CELL UPDATE CONFIRM message at event 406. Then, at event 409, user plane data transfer, in the uplink and/or downlink directions, can now take place using, for example, the HSPA resources that are available in the Cell_DCH state 205.

The event sequence diagrams 300 and 400 of FIGS. 3 and 4 illustrate an example of the data transfer latency that can be caused by a delayed state transition from the Cell_FACH state 210 to the Cell_DCH state 205 in the UTRAN 100. For example, in the event sequence diagram 300, the UTRAN 100 permits some user plane data transfer to occur in the Cell_FACH state 210 and waits until later to make the decision to move the mobile station 135 to the Cell_DCH state 205. In contrast, in the event sequence diagram 400, the UTRAN 100 moves the mobile station 135 into the Cell_DCH state 205 after receipt of the CELL UPDATE message, thereby enabling resources of the Cell_DCH state 205 to be available more quickly.

With reference to the preceding examples, various types of information may be used by the UTRAN 100 to decide when to move the mobile station 135 into the Cell_DCH state 205. Such information may include, for example, uplink traffic volume measurements (TVM) in a MEASUREMENT REPORT message, a traffic volume indicator (TVI) in a CELL UPDATE message, an amount of downlink RLC data determined to be buffered in the RNC 120 for transmission to the mobile station 135, measured cell and/or network loading, the length of time since previous data activity, etc., and/or any combination thereof.

With reference to the event sequence diagram 300 of FIG. 3, if the mobile station 135 is initially in the Cell_FACH state 210 and has uplink data to send, the mobile station 135 may be able to start sending that data immediately. Such a sequence of events corresponds to events 307-313 in the example event sequence diagram 300 of FIG. 3. For example, it may not be necessary for the RRC signaling corresponding to the cell update procedure (e.g., events 304-306 of FIG. 3) to occur before the data transfer. In such examples, if the amount of uplink RLC data buffered in the mobile station 135 exceeds a configured threshold, the mobile station 135 then triggers sending of a MEASUREMENT REPORT message containing traffic volume information to inform the UTRAN 100 about the amount of uplink RLC data buffered in the mobile station 135. In response to this MEASUREMENT REPORT message, the UTRAN 100 may make a decision to move the mobile station 135 into the Cell_DCH state 205. Alternatively, the UTRAN 100 may make a decision to move the mobile station 135 into the Cell_DCH state 205 based on the amount of downlink RLC data buffered in the RNC 120 for transmission to the mobile station 135.

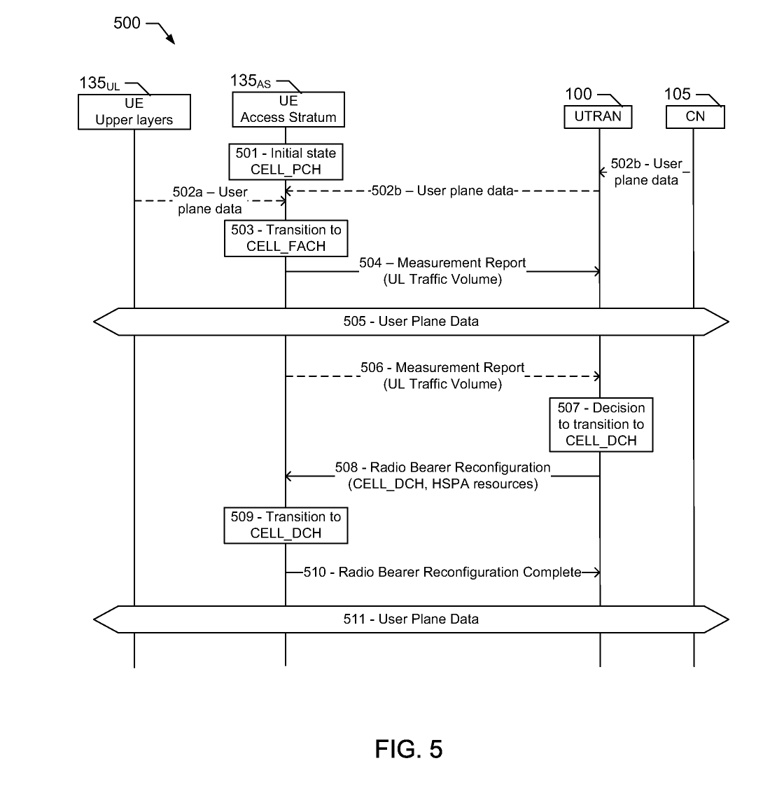

FIG. 5 depicts an example event sequence diagram 500 illustrating an example sequence of event that may occur when the mobile station 135 is in the Cell_PCH state 215, data activity is to be resumed, and the UTRAN 100 and UE 135 support the Enhanced Cell_FACH feature in Cell_PCH. In the illustrated example of FIG. 5, the mobile station 135 and the UTRAN 100 are assumed to be compliant with prior 3GPP UMTS specifications and, thus, do not include the state transition processor 140 and/or the state configuration processor 145 to reduce data transfer latency caused by RRC state transitions as disclosed herein. The Enhanced Cell_FACH feature was introduced in Release 7 of the 3GPP UMTS specifications. With this feature, mobile stations, such as the mobile station 135, that are in the Cell_FACH state 210 can be configured to receive downlink signaling and/or data via the HS-DSCH transport channel, instead of via the forward access channel (FACH). The use of the HS-DSCH transport channel in the downlink can provide higher throughput and shorter delays as compared with the use of the FACH transport channel. Another aspect of the Enhanced Cell_FACH feature is that a mobile station 135 in the Cell_PCH state 115 can be configured to receive downlink signaling and/or data via the HS-DSCH transport channel, instead of monitoring the paging channel. This can improve the transition from the Cell_PCH state 215 to the Cell_FACH state 210 by eliminating the CELL UPDATE and CELL UPDATE CONFIRM messages that are shown in the sequences 300 and 400 of FIGS. 3 and 4. As described in the 3GPP UMTS specifications, when the mobile station 135 and the UTRAN 100 support Enhanced Cell_FACH in the Cell_PCH state 215, the mobile station 135 is configured with a dedicated H-RNTI and a C-RNTI (where RNTI refers to radio network temporary identifier).

Turning to FIG. 5, the example event sequence diagram 500 shows an example sequence of events that may occur when the mobile station 135 is initially in the Cell_PCH state 215 with no user plane data activity, and then user plane data activity is to be resumed. In the illustrated example of FIG. 5, the UTRAN 100 supports the Enhanced Cell_FACH feature. As such, at event 501, the mobile station 135 is initially in the Cell_PCH state 215. Additionally, the mobile station 135 is configured with a C-RNTI, an H-RNTI and the appropriate HS-DSCH information to enable reception of downlink messaging/data via the HS-DSCH.

Events 502a/b correspond to user plane data activity being resumed. This resumption of data activity may be mobile originated, for example, due to an application in the mobile station 135 starting to generate uplink data, which is depicted as event 502a. In response to the mobile originated resumption of data activity, the mobile station 135 transitions from the Cell_PCH state 215 to the Cell_FACH state 210 at event 503.

Alternatively, this resumption of data activity may be mobile terminated, which corresponds to the events collectively labeled as event 502b, in which case downlink data arrives in the UTRAN 100 and the UTRAN 100 forwards this downlink data to the mobile station 135 via the HS-DSCH. In response to receiving data via the HS-DSCH (or, more specifically, in response to receiving downlink scheduling indication sent to the mobile station's H-RNTI over the HS-high speed shared control channel (HS-SCCH)), the mobile station 135 transitions from the Cell_PCH state 215 to the Cell_FACH state 210 at event 503.

At event 504, the mobile station 135 sends a MEASUREMENT REPORT message to the UTRAN 100. As described in the 3GPP UMTS specifications, in the case of the Enhanced Cell_FACH feature, this MEASUREMENT REPORT message uses a fixed value of “16” for the “measurement identity” although no measurement may have been configured by the UTRAN 100 with this value for the “measurement identity.” In response to receiving this fixed value of “16,” the UTRAN 100 may determine that the mobile station 135 has moved out of the Cell_PCH state 215 into the Cell_FACH state 210. Additionally, as described in the 3GPP UMTS specifications, in the mobile originated case, the MEASUREMENT REPORT message could contain a “Traffic Volume Event Identity” set to a value of “4a” to indicate that an amount of uplink RLC data buffered in the mobile station 135 exceeds a threshold. For example, the mobile station 135 may send a “Traffic Volume Event Identity” set to a value of “4a” if the sending of this indication has been configured by the UTRAN 100 by configuring appropriate traffic volume measurement information, including the “event 4a” threshold, within system information or within a MEASUREMENT CONTROL message sent to the mobile station 135.

At event 505, user plane data transfer in the uplink and/or downlink directions may now take place. Note that in the mobile originated case, if the MEASUREMENT REPORT sent in event 504 included the traffic volume event “4a,” then the uplink transmission of user data may be inhibited for an amount of time configured by the UTRAN 100 as part of the traffic volume measurement information. This provides a time window in which the UTRAN 100 can choose to move the mobile station 135 to the Cell_DCH state 205 before the uplink data is sent.

If the amount of uplink RLC data buffered in the mobile station 135 exceeds a configured threshold (e.g., assuming that an appropriate traffic volume measurement has been configured by the UTRAN 100) then at event 506 the mobile station 135 triggers sending of a MEASUREMENT REPORT message containing traffic volume information to inform the UTRAN 100 of the amount of uplink RLC data buffered in the mobile station 135.

In the illustrated example of FIG. 5, at event 507, the UTRAN 100 decides to move the mobile station 135 into the Cell_DCH state 205. This decision may be based on, for example, the amount of uplink RLC data buffered in the mobile station 135, whether the UTRAN 100 has received the “Traffic Volume Event Identity” set to “4a” at step 504 of the sequence 500, whether the UTRAN 100 received the MEASUREMENT REPORT message at event 506, the amount of downlink RLC data buffered in the RNC 120 for transmission to the mobile station 135, etc.

At event 508, the UTRAN 100 sends a reconfiguration message, such as a RADIO BEARER RECONFIGURATION message, to command the mobile station 135 to move to the Cell_DCH state 205. In some examples, this message could also configure the mobile station 135 with an HS-DSCH channel in the downlink direction and an E-DCH channel in the uplink direction (which are collectively referred to as HSPA resources).

At event 509, the mobile station 135 transitions from the Cell_FACH state 210 to the Cell_DCH state 205. Furthermore, at event 510, the mobile station 135 sends a reconfiguration complete message to the UTRAN 100. For example, if the reconfiguration message at event 508 is the RADIO BEARER RECONFIGURATION message, then at event 510 the reconfiguration complete message would be the RADIO BEARER RECONFIGURATION COMPLETE message. At event 511, user plane data transfer, in the uplink and/or downlink directions, can now take place using, for example, the HSPA resources that are available in the Cell_DCH state 205.

With reference to the event sequence diagram 500 of FIG. 5, when the UTRAN 100 supports the Enhanced Cell_FACH feature, various types of information may be used by the UTRAN 100 to decide when to move the mobile station 135 into the Cell_DCH state 205. Such information may include, for example, uplink traffic volume measurements (TVM) in the MEASUREMENT REPORT message provided, for example, at event 506 of FIG. 5 (which corresponds to the information provided in the MEASUREMENT REPORT message at event 308 of FIG. 3). Additionally or alternatively, such information may include the “Traffic Volume Event Identity” included in the MEASUREMENT REPORT message at event 504 (which is comparable to the TVI included in the CELL UPDATE message in the example of FIG. 3). Additionally or alternatively, such information can include the amount of downlink RLC data buffered in the RNC 120 for transmission to the mobile station 135.

With reference to the event sequence diagram 500 of FIG. 5, it is possible that the RNC 120 of the UTRAN 100 may decide to move the mobile station 135 into the Cell_DCH state 205 at event 502b of the sequence (e.g., just after the initial data arrived in the RNC 120 from the core network 105). In such an example, the RNC 120 could choose to send a RADIO BEARER RECONFIGURATION message at event 502b to command the mobile station 135 to move to the Cell_DCH state 205, instead of sending the user plane data to the mobile station 135 as shown.

With reference to the event sequence diagram 500 of FIG. 5, if the mobile station 135 is initially in the Cell_FACH state 210 and has uplink data to send, and the Enhanced Cell_FACH feature is supported, the mobile station 135 may be able to start sending that data immediately. Such a sequence of events corresponds to events 505-511 in the example event sequence diagram 500 of FIG. 5. For example, it may not be necessary for the RRC signaling corresponding to the MEASUREMENT REPORT at event 504 to occur before the data transfer. In such examples, if the amount of uplink RLC data buffered in the mobile station 135 exceeds a configured threshold, the mobile station 135 then triggers sending of a MEASUREMENT REPORT message containing traffic volume information to inform the UTRAN 100 about the amount of uplink RLC data buffered in the mobile station 135. In response to this MEASUREMENT REPORT message, the UTRAN 100 may make a decision to move the mobile station 135 into the Cell_DCH state 205. Alternatively, the UTRAN 100 may make a decision to move the mobile station 135 into the Cell_DCH state 205 based on the amount of downlink RLC data buffered in the RNC 120 for transmission to the mobile station 135.

Although FIG. 1 depicts an example UMTS radio access network 100, the disclosed example methods, apparatus and articles of manufacture for reducing data transfer latency caused by state transitions can be utilized in other mobile networks, such as a 3GPP-compliant Long Term Evolution (LTE) network. An LTE network supports an RRC state machine having an RRC Idle mode and an RRC Connected mode, but it does not have separate states, such as the Cell_DCH state 205, the Cell_FACH state 210, etc., within the RRC Connected mode. Consequently, an LTE basestation (also referred to as an enhanced Node-B or eNB) does not need to determine the most appropriate RRC state (other than the choice between Idle and Connected) in which to place a mobile station, such as the mobile station 135. However, the eNB does make decisions about the configuration of various features, such as DRX (e.g., including DRX cycle, inactivity time, etc.), uplink packet data control channel (PDCCH) resources (e.g., such as periodic channel quality indicator (CQI), dedicated scheduling request resource (D-SR), sounding reference symbols (SRS), etc.), data rate and throughput enhancing features, such as multi-input multi-output (MIMO), etc.

The process by which the eNB decides if and how to configure the foregoing features, which is not specified by 3GPP, could be based on a variety of factors, such as uplink buffer status reports (BSRs) received from the mobile station, the amount(s) of data buffered in the eNB for transmission to the mobile station (e.g., which may be buffered in the packet data convergence protocol (PDCP) and/or RLC layers), the quality of service (QoS) requirements of the currently configured radio bearers, other radio information (such as that provided by the mobile station in MEASUREMENT REPORTS or channel quality indicator (CQI) indications), etc., or any combination(s) thereof. For example, LTE-compliant mobile stations send uplink BSRs to provide the eNB with the amount of uplink data buffered in the mobile station's RLC and PDCP layers. BSRs are transmitted in the MAC layer within a MAC protocol data unit (PDU). A BSR is triggered when there is currently no uplink data buffered on any radio bearer and new uplink data arrives. A BSR is also triggered when new uplink data arrives on a radio bearer that belongs to a group with a higher priority than any group for which uplink data is currently buffered. A BSR can also be configured to be triggered periodically.

As illustrated in the preceding examples, when the mobile station 135 operating in the UTRAN 100 of FIG. 1 has been inactive in the Cell_PCH state 215 or the URA_PCH state 220 and then resumes data activity, the UTRAN 100 decides if and when to move the mobile station to the Cell_DCH state 205. Similarly, an LTE network may decide if and when to implement particular LTE features for a particular LTE-compliant mobile station based on the data activity of the mobile station. However, inadequate indications of a mobile station's expected data activity and/or possible state transition race conditions in prior UMTS and LTE radio access networks can cause such decisions to be delayed, which can cause unnecessary latency in the data transfers to/from the mobile station.

For example, the uplink RLC buffer status information provided by the mobile station 135 to the UTRAN 100 in the example event sequence diagrams 300, 400 and 500 described above (which assume that the mobile station 135 and the UTRAN 100 do not include the state transition processor 140 and/or the state configuration processor 145 to reduce data transfer latency caused by RRC state transitions as disclosed herein) can be a poor indication of the expected data activity of the mobile station 135. If the mobile station's data activity is going to involve very little data being transferred, such as when an application running on the mobile station 135 is sending a keep alive message or a status update, then it may be desirable for the UTRAN 100 to allow this data activity to occur in the Cell_FACH state 210. Moving the mobile station 135 to the Cell_DCH state 205 for such a data activity may be a poor use of UTRAN resources. Moreover, unnecessary power consumption in the mobile station 135 can result if the UTRAN 100 leaves the mobile station 135 in the Cell_DCH state 205 after the data activity has completed.

Conversely, if the mobile station's data activity is going to be significant, such as when a user of the mobile station 135 is going to send or receive large emails or download web pages, then it may be desirable for this data activity to occur in the Cell_DCH state 205. For example, if the UTRAN 100 initially places the mobile station 135 into the Cell_FACH state 115, and waits until a large amount of downlink data arrives in the RNC 120, or a large amount of uplink data is submitted to the mobile station's RLC layer, to move the mobile station 135 to the Cell_DCH state 205, then there may be extra delay and a poor user experience.

However, the Traffic Volume Indicator (TVI) in the CELL UPDATE message described above in connection with FIG. 3 (or, in the case of Enhanced Cell_FACH feature, the Traffic Volume Event Identity included in the MEASUREMENT REPORT sent with Measurement Identity=16 and described above in connection with FIG. 5) only relates to the uplink data within the mobile station's RLC buffers and, furthermore, only to the first amount of data sent. Accordingly, such information may not be a good indication of the expected data activity of the mobile station 135. For example, a small amount of uplink data may lead to large amounts of downlink data (e.g., in the case of web page accesses), or a small uplink message may be followed by a large uplink message (e.g., in the case of data file uploads), etc. In such scenarios, the longer the UTRAN 100 takes to move the mobile station 135 to the CELL-DCH state 205, the more the data transfer latency will be increased. Prior UMTS radio access networks are unable to exploit knowledge or information that may be available within the mobile station concerning the data transfers/transactions that is/are expected to occur in the future.

Another potential issue is the configuration of the threshold (e.g., the “event 4a” threshold) for controlling inclusion of the TVI in the CELL UPDATE message. If the threshold is set too small, the mobile station 135 may be commanded to move into the CELL-DCH state 205 too often, which can reduce battery lifetime. Many existing UMTS networks do set the threshold to a very small value, such as to only 8 bytes, and hence transition to mobile station to move to CELL_DCH when not necessary. Conversely, if the threshold is set too large, the mobile station 135 will not be moved to the CELL-DCH state 135 enough, thereby also wasting battery life and also increasing data transfer latency. According to the 3GPP UMTS specifications, the possible sizes for the event 4a″ threshold are: Enumerated(8, 16, 32, 64, 128, 256, 512, 1024, 2K, 3K, 4K, 6K, 8K, 12K, 16K, 24K, 32K, 48K, 64K, 96K, 128K, 192K, 256K, 384K, 512K, 768K).

Similar considerations apply to LTE networks. For example, if the mobile station's data activity involves very little data being transferred, such as when an application running on the mobile station 135 is sending keep alive or status updates, as mentioned above, then it may be unnecessary for the Enhanced-UTRAN (E-UTRAN) implementing the LTE network to configure one or more of the LTE data rate and/or throughput enhancing features mentioned above, such as the MIMO feature. Alternatively, if the mobile station's data activity is going to be significant, such as when a user of the mobile station is going to send or receive large emails or download web pages, then it may be desirable for these LTE features to be configured. If the E-UTRAN initially does not configure these features, and then waits until a large amount of downlink data arrives in the eNB, or a large amount of uplink data is submitted to the mobile station's PDCP/RLC layers for transmission, to enable the data rate and/or throughput enhancing feature, then there may be extra delay and a poor user experience. Conversely, if the E-UTRAN initially configures these features, but then finds that very little data needs to be transferred, then the E-UTRAN may have reserved radio and network resources unnecessarily, which can lead to sub-optimal use of radio and network resources.

Also, as with the traffic volume information provided by the mobile station 135 in the UMTS radio access network 100, in an LTE network, the BSR provided by the mobile station only relates to the uplink data in the mobile station's PDCP and RLC buffers and, furthermore, initially only relates to the first amount of data to be sent. However, as noted above, a small initial amount of data can lead to much larger amounts of data in either the uplink or downlink directions.

Prior UMTS radio access networks can also experience data transfer latencies resulting from race conditions related to state transitions. For example, in prior UTRANs and during some use-case scenarios involving radio link failure, race conditions related to uplink data transmission and RRC state transitions from the Cell_DCH state 205 to the Cell_FACH state 210, RLC unrecoverable error, etc., the mobile station might have a large amount of uplink data to send. In such scenarios, it would be beneficial for the mobile stations to be able to inform the UTRAN of its uplink buffer status as soon as possible. However, in at least some of these scenarios, the prior 3GPP UMTS specifications require the UTRAN to have the mobile station perform multiple re-configuration steps before the mobile station can inform the network of its pending uplink data, which can increase connection latency, have a negative impact on the end-user experience, increase the signaling load in the UTRAN, etc.

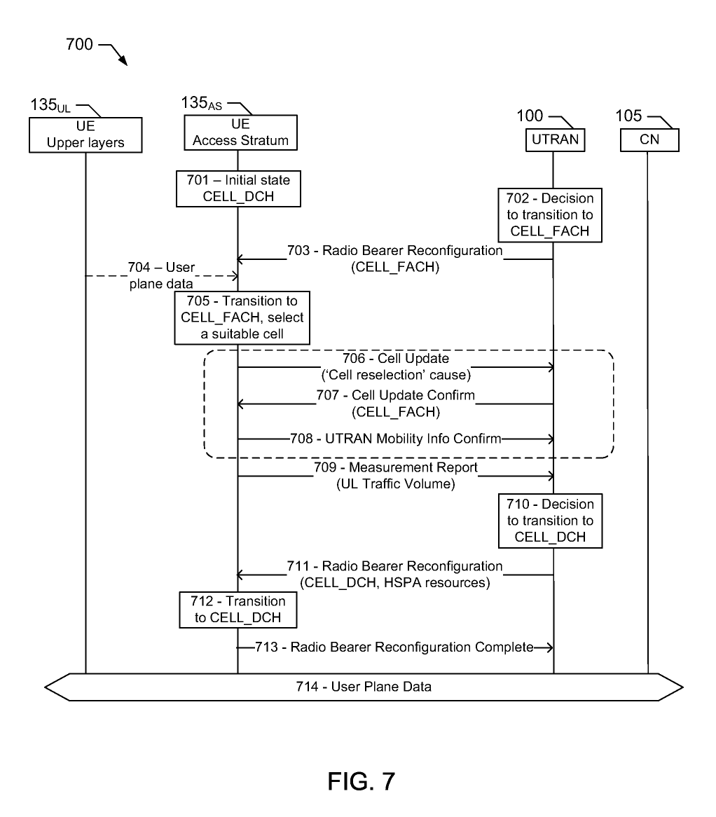

FIG. 7 depicts an example event sequence diagram 700 illustrating one such possible race condition. In the illustrated example of FIG. 7, the mobile station 135 and the UTRAN 100 are assumed to be compliant with prior 3GPP UMTS specifications and, thus, do not include the state transition processor 140 and/or the state configuration processor 145 to reduce data transfer latency caused by RRC state transitions as disclosed herein. Turning to FIG. 7, the example event sequence diagram 700 shows an example sequence of events that may occur when the mobile station 135 is initially in the Cell_DCH state 205 with no user plane data activity. As there is no data activity, in the illustrated example, the UTRAN 100 decides to move the mobile station to the Cell_FACH state 210. At approximately the same time, the mobile station 135 has more uplink data to transmit. The event sequence diagram 700 shows the signaling to be performed before the mobile station 135 can return to the Cell_DCH state 205 and resume data activity.

In particular, at event 701 of the event sequence diagram 700, the mobile station 135 is initially in the Cell_DCH state 205, and there is no user plane data activity. At event 702, the UTRAN 100 decides to move the mobile station 135 into the Cell_FACH state 210. This decision could be based on the expiry of an “inactivity timer” indicating that there has been no user plane data activity for a particular period of time. Accordingly, at event 703, the UTRAN 100 sends a reconfiguration message, such as a RADIO BEARER RECONFIGURATION message, to command the mobile station 135 to move to the Cell_FACH state 210.

Event 704 corresponds to an example race condition in which the upper layers 135_{UL} within the mobile station 135 generate uplink data any time after the UTRAN 100 has decided to move the mobile station 135 into the Cell_FACH state 210 (corresponding to event 703) but before the mobile station 135 sends a subsequent CELL UPDATE message (e.g., occurring at event 706, which is described below).

In response to receiving the reconfiguration message at event 703 commanding the mobile station 135 to move to the Cell_FACH state 210, the mobile station 135 performs a number of actions at event 705 (under the assumption that the mobile station 135 is conforming to the prior 3GPP UMTS specifications in the illustrated example and, thus, is not able to reduce data transfer latency caused by RRC state transitions as disclosed herein). For example, at event 705, the mobile station 135 transitions to the Cell_FACH state 210, selects a suitable cell on which to camp, and reads the system information of the selected cell. These actions may take up to several seconds depending on how frequently the system information is broadcast, the radio conditions of the cell, etc. The longer these actions take, the higher the probability that event 704 will occur or, in other words, the higher the probability that uplink data will be generated before the CELL UPDATE message is transmitted by the mobile station 135.

At event 706, the mobile station 135 sends a CELL UPDATE message to the UTRAN 100 with a cause value that would be set to “cell reselection” in the illustrated example. According to the prior 3GPP UMTS specifications, because the cause value is set to “cell reselection” and not “uplink data transmission,” the mobile station 135 would not be able to include the TVI in the CELL UPDATE message even if the amount of uplink RLC data buffered in the mobile station 135 (e.g., due to event 704) exceeds the configured (e.g., “event 4a”) threshold.

At event 707, the UTRAN 100 responds to the CELL UPDATE message with a CELL UPDATE CONFIRM message, which commands the mobile station 135 to remain in the Cell_FACH state 210. At event 708, the mobile station 135 responds to a CELL UPDATE CONFIRM message with a message dependent on the IEs included in the CELL UPDATE CONFIRM message. In the illustrated example, the response message is a UTRAN MOBILITY INFORMATION CONFIRM message.

In the illustrated example, at event 709 the amount of uplink RLC data buffered in the mobile station 135 exceeds a configured threshold (e.g., the “event 4a” threshold), which causes the mobile station 135 to trigger sending of a MEASUREMENT REPORT message. The MEASUREMENT REPORT message contains traffic volume information to inform the UTRAN 100 about the amount of uplink RLC data buffered in the UE. Based on how the UTRAN 100 configured the traffic volume measurement reporting, the transmission of uplink data buffered within the mobile station's RLC layer may begin while the mobile station 135 is still in the Cell_FACH state 210 (e.g., by using the uplink dedicated traffic channel (DTCH) on the random access channel (RACH)) or the uplink data transmission may be suspended for a time period to allow the UTRAN 100 to move the mobile station 135 to the Cell_DCH state 205.

In the illustrated example, at event 710 the UTRAN 100 decides to move the mobile station 135 into the Cell_DCH state 205. This decision may be based on, for example, the amount of uplink RLC data buffered in the mobile station 135. Accordingly, at event 711, the UTRAN 100 sends a reconfiguration message, such as a RADIO BEARER RECONFIGURATION message, to command the mobile station 135 to move to the Cell_DCH state 205. In some examples, this message would also configure the mobile station 135 with an HS-DSCH channel in the downlink direction and an E-DCH channel in the uplink direction (which are referred to collectively as HSPA resources).

In response to receiving the RADIO BEARER RECONFIGURATION message, at event 712 the mobile station 135 transitions from the Cell_FACH state 210 to the Cell_DCH state 205, and at event 713 the mobile station 135 sends the RADIO BEARER RECONFIGURATION COMPLETE message to the UTRAN 100. Then, at event 714, user plane data transfer in the uplink and/or downlink directions can now take place using, for example, the allocated HSPA resources.

Table 2 includes an excerpt of an example mobile-side log corresponding to the example event sequence diagram 700 as observed in a commercial network (which, along with the mobile station, did not support reducing data transfer latency caused by state transitions as disclosed herein). For the example log of Table 2, the mobile station had uplink data pending during the transition from the Cell_DCH state 205 to the Cell_FACH state 210. Before informing the network regarding its uplink buffer status, the mobile station had to go through following steps: cellUpdate (cause: cellReselection)→cellUpdateConfirm (RRC State: Cell_FACH)→utranMobilityInformationConfirm→radioBearerReconfigurationComplete→measurementReport (TVM: e4a)→radioBearerReconfiguration (RRC State: Cell_DCH). The example log of Table 2 demonstrates a latency of approximately 1.75 seconds for the transition back to the Cell_DCH state 205, corresponding to the events from radioBearerReconfiguration{RRC State:Cell_FACH} to radioBearerReconfiguration{RRC State:Cell_DCH}.

TABLE 2
Logged Event (Time stamp; direction uplink (UL) or downlink (DL);
message; message content)

13:41:22.755; DL; radioBearerReconfiguration;
rrc-StateIndicator cell-FACH,
13:41:23.782; UL; cellUpdate;
cellUpdateCause cellReselection,
13:41:23.976; DL; cellUpdateConfirm;
rrc-StateIndicator cell-FACH,
13:41:23.979; UL; utranMobilityInformationConfirm;
13:41:23.980; UL; radioBearerReconfigurationComplete;
13:41:23.985; UL; measurementReport;
measurementIdentity 4,
trafficVolumeEventIdentity e4a
13:41:24.492; UL; measurementReport;
measurementIdentity 4,
trafficVolumeEventIdentity e4a
13:41:24.516; DL; radioBearerReconfiguration;
rrc-StateIndicator cell-DCH

In the example event sequence diagram 700, the cell update procedure of steps 706-708 (enclosed within a dotted line in FIG. 7) may not be performed in some cases. For example, if the RADIO BEARER RECONFIGURATION message at event 703 allocates a C-RNTI and includes a cell identity (e.g., the primary scrambling code of the cell), and the mobile station 135 selects the identified cell, then the mobile station 135 can use the allocated C-RNTI to send and receive in that cell. In such cases, no cell update procedure is required. In other cases, the cell update procedure may need to be performed for the mobile station 135 to be allocated with a C-RNTI for the cell that it has selected.

Table 3 includes an excerpt of an example mobile-side log corresponding to such a case of the example event sequence diagram 700 in which the cell update procedure of steps 706-708 is not performed (and in which the mobile station and UTRAN did not support reducing data transfer latency caused by state transitions as disclosed herein). For the example log of Table 3, the UTRAN directs the mobile station to the Cell_FACH state 210 through a radioBearerReconfiguration. In the example of Table 3, as the mobile station is reading the system information of the target cell, which takes approximately 1 second, uplink data arrived in the mobile's RLC buffer. In this example, the mobile station first sends a radioBearerReconfigurationComplete and then triggers measurementReport carrying Traffic Volume Measurement (TVM). After receiving the TVM, the network moves the UE into the Cell_DCH state 205. The example log of Table 3 demonstrates a latency of approximately 1.4 seconds for the transition back to the Cell_DCH state 205, corresponding to the events from radioBearerReconfiguration{RRC State:Cell_FACH} to radioBearerReconfiguration{RRC State: Cell_DCH}.

TABLE 3
Logged Event (time stamp; direction uplink(UL)or downlink(DL);
message; message content)

0.000; DL; radioBearerReconfiguration;
rrc-StateIndicator cell-FACH,
C-RNTI,
Primary Scrambling Code (PCI)
0.047; DL; start reading systemInformation messages
0.844; UL; radioBearerReconfigurationComplete;
0.844; UL; measurementReport;
1.422; DL; radioBearerReconfiguration;
rrc-StateIndicator cell-DCH

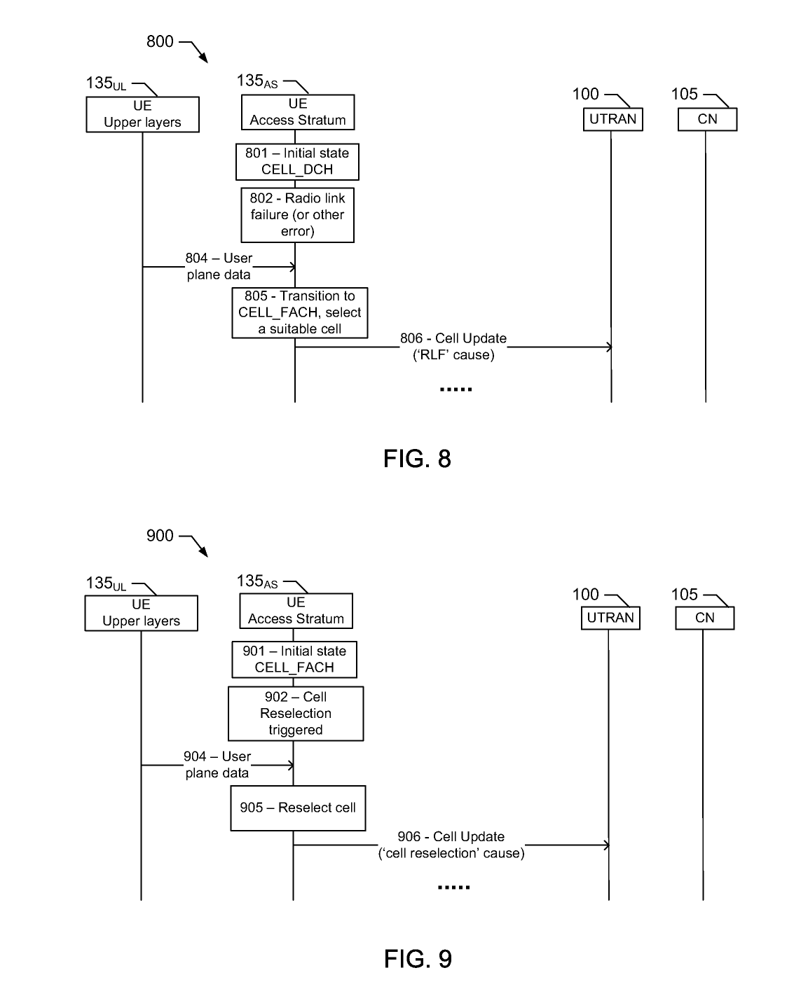

FIGS. 8 and 9 illustrate respective example event sequence diagrams 800 and 900 corresponding to other possible race conditions that lead to scenarios in which a mobile station is in the Cell_FACH state 210 and is caused to go through a lengthy sequence of RRC procedures before the mobile station can return to the Cell_DCH state 205 and continue data activity. In the illustrated examples of FIGS. 8 and 9, the mobile station 135 and the UTRAN 100 are assumed to not support reducing data transfer latency caused by state transitions as disclosed herein. The example event sequence diagram 800 of FIG. 8 shows an example sequence of events in which mobile station 135 is initially in the Cell_DCH state 205 (corresponding to event 801) and a radio link failure or some other error, such as an RLC unrecoverable error, occurs (corresponding to event 802). After the radio link failure or other error occurs and before it is able to send the CELL UPDATE message, uplink data arrives in the mobile station 135 (corresponding to event 804). This failure/error causes the mobile station 135 to move to the Cell_FACH state 210 (corresponding to event 805) and initiate a cell update procedure (corresponding to event 806). The resulting CELL UPDATE message, therefore, contains a cause value that would be set accordingly to “radio link failure,” or “RLC unrecoverable error,” etc., as the case may be. Accordingly, the TVI would not be included in the CELL UPDATE message even if the amount of uplink RLC data buffered in the mobile station 135 exceeds a configured threshold (e.g., the “event 4a” threshold) as the cause value would not be “uplink data transmission.” (This is because the mobile station 135 and the UTRAN 100 are assumed, in the example of FIG. 8, to not support reducing data transfer latency caused by state transitions as disclosed herein). Events 707-714 of FIG. 7, which are described above, may then occur after event 806 of the event sequence diagram 800 of FIG. 8.

The example event sequence diagram 900 of FIG. 9 shows an example sequence of events in which the mobile station 135 is initially in the Cell_FACH state 210 (corresponding to event 901) and a cell reselection is triggered (corresponding to event 902). After the mobile station 135 leaves its current serving cell and before it is able to send the CELL UPDATE message on the new cell, uplink data arrives in the mobile station 135 (corresponding to event 904). Such a sequence of events may occur, for example, in the case of an inter-frequency cell reselection as the mobile station 135 must leave its current serving cell, then switch frequency and read system information of the new cell, before the mobile station 135 can start the cell update procedure. (In contrast, in the case of an intra-frequency cell reselection, the mobile station 135 is able to read the system information of the new cell before it actually leaves its current serving cell, making the example scenario of FIG. 9 less likely to occur). The resulting CELL UPDATE message, therefore, contains a cause value that would be set to “cell reselection.” Accordingly, the TVI would not be included in the CELL UPDATE message even if the amount of uplink RLC data buffered in the mobile station 135 exceeds a configured threshold (e.g., the “event 4a” threshold) as the cause value would not be “uplink data transmission.” (This is because the mobile station 135 and the UTRAN 100 are assumed, in the example of FIG. 9, to not support reducing data transfer latency caused by state transitions as disclosed herein). Events 707-714 of FIG. 7, which are described above, may then occur after event 906 of the event sequence diagram 900 of FIG. 9.

FIG. 10 illustrates an example state transition processor 140 that can be used to implement the example mobile station 135 of FIG. 1. The state transition processor 140 of FIG. 10 performs (e.g., executes, follows, etc.) one or more example processes, or combination(s) thereof, that implement solution(s) from one or more families of example solutions disclosed herein for reducing data transfer latency caused by state transitions in mobile networks. In the illustrated example of FIG. 10, the state transition processor 140 processes messages received from the UTRAN 100 via an example message transceiver 1005, and prepares appropriate messages and message contents to send to the UTRAN 100 via the message transceiver 1005. The message transceiver 1005 implements any appropriate transmitter and receiver functionality to exchange messages with the UTRAN 100.

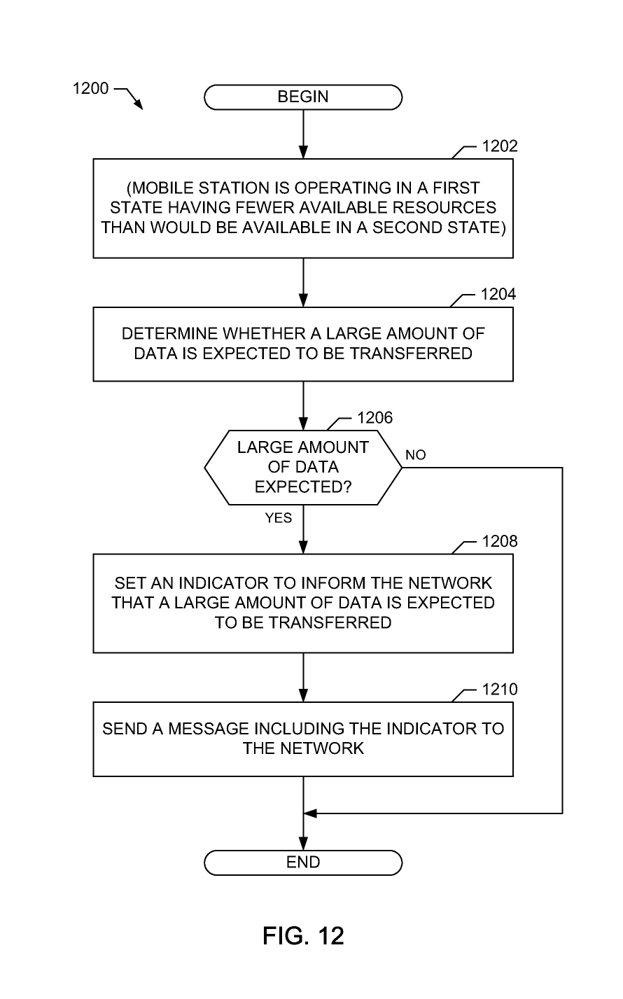

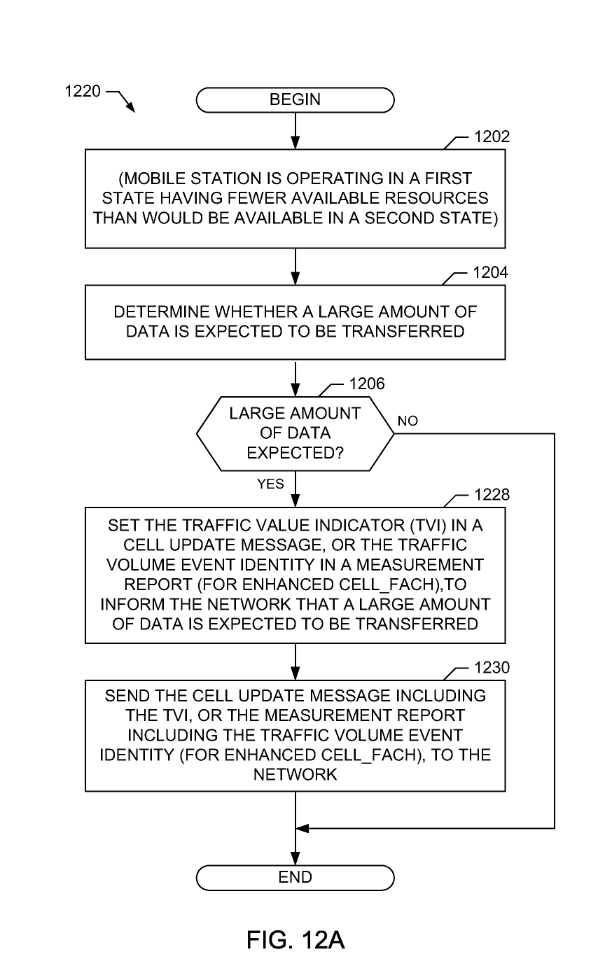

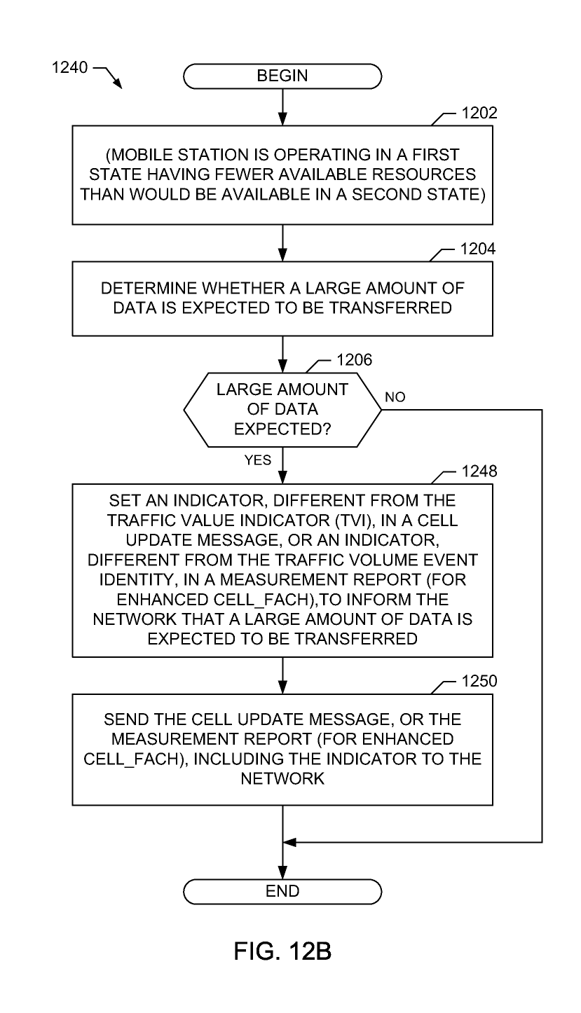

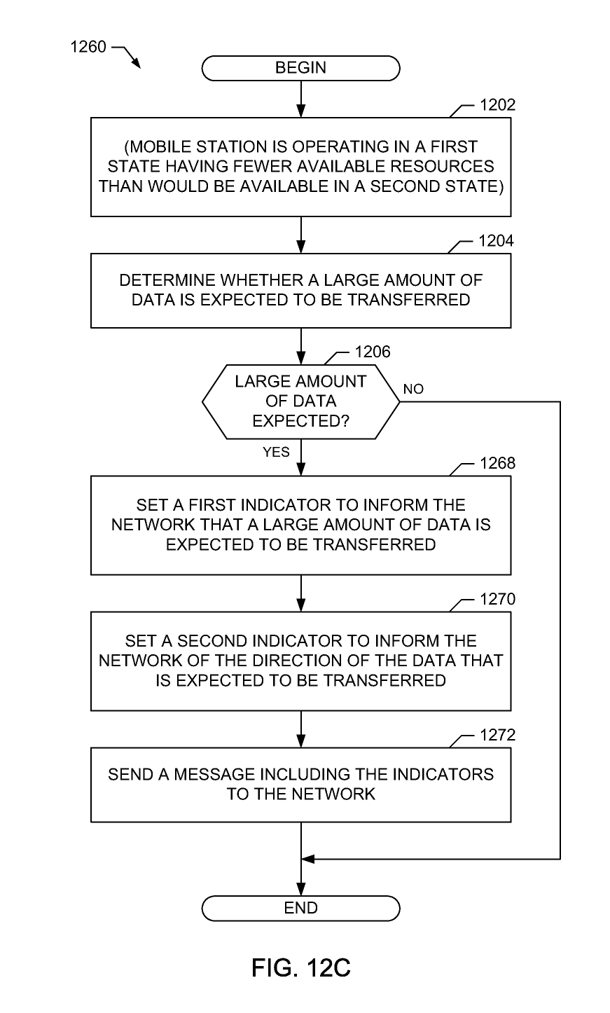

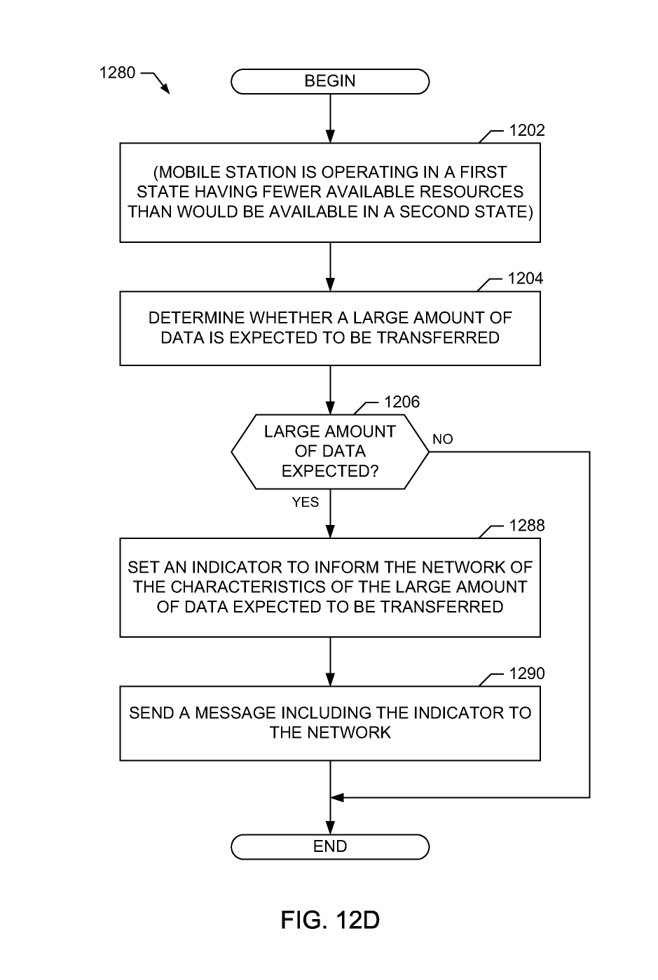

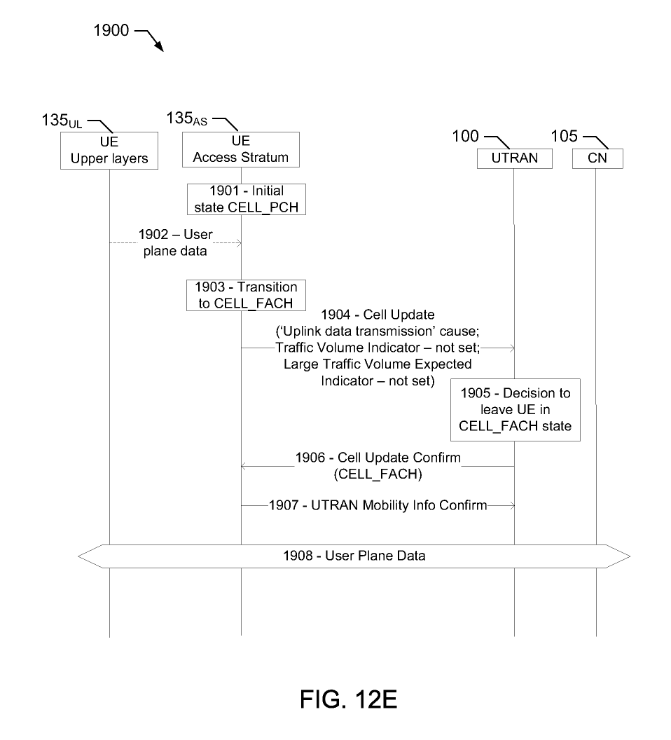

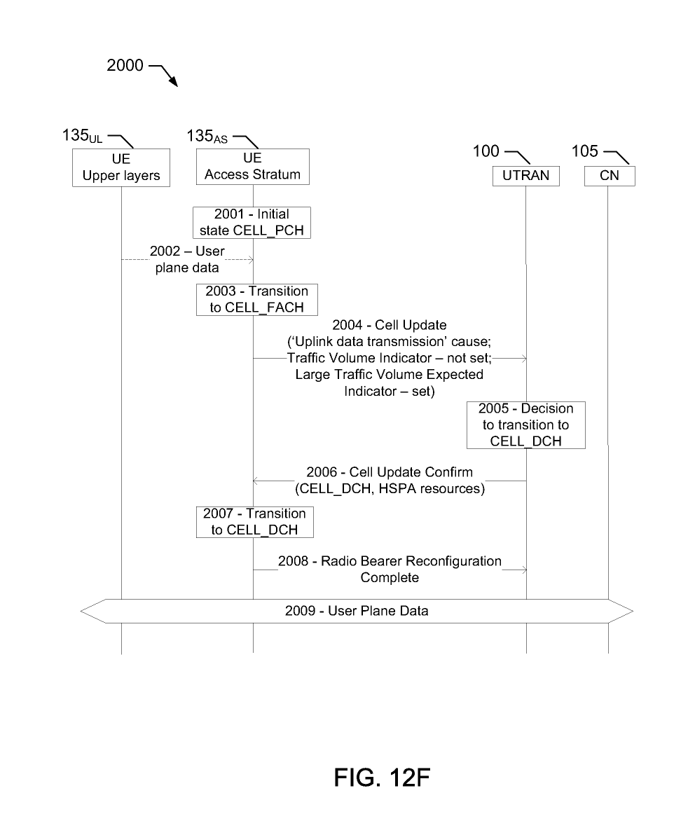

To prepare the appropriate messages and message contents to send to the UTRAN 100, the state transition processor 140 of FIG. 10 includes an example data transmission evaluator 1010 and an example message preparer 1015. The data transmission evaluator 1010 of the illustrated example evaluates (e.g., determines, predicts, etc.) the amount(s) (and possibly direction and/or other characteristics) of uplink data and/or downlink data that is(are) expected to be transferred between the mobile station 135 and the UTRAN 100. The message preparer 1015 of the illustrated example then prepares message(s) and message content(s) to send to the UTRAN 100 based on the evaluation performed by the data transmission evaluator 1010. Example implementations and operations of the data transmission evaluator 1010 and the message preparer 1015 are described in greater detail below and in the context of FIGS. 12-17.

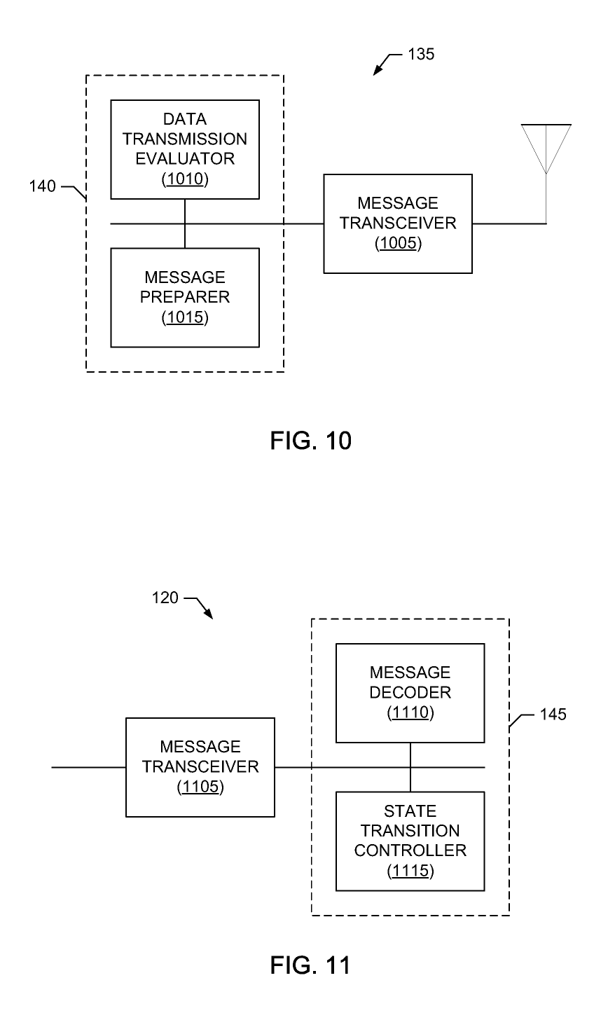

FIG. 11 illustrates an example state configuration processor 145 that can be used to implement the example RNC 120 of FIG. 1. The state configuration processor 145 of FIG. 11 performs (e.g., executes, follows, etc.) one or more example processes, or combination(s) thereof, that implement solution(s) from one or more families of example solutions disclosed herein for reducing data transfer latency caused by state transitions in mobile networks. In general, the process(es) performed by the state configuration processor 145 of the RNC 120 of FIG. 1 are the counterpart(s) of the process(es) performed by the state transition processor 140 of the mobile station 135 of FIG. 11. Accordingly, in the illustrated example of FIG. 11, the state configuration processor 145 processes messages received from the mobile station 135 via an example message transceiver 1105, and prepares appropriate messages and message contents to send to the mobile station 135 via the message transceiver 1105. The message transceiver 1105 implements any appropriate transmitter and receiver functionality to exchange messages with the mobile station 135.

To prepare the appropriate messages and message contents to send to the mobile station 135, the state configuration processor 145 of FIG. 11 includes an example message decoder 1110 and an example state transition controller 1115. The message decoder 1110 of the illustrated example decodes message(s) received from the mobile station 135 providing information concerning the amount(s) (and possibly direction and/or other characteristics) of uplink data and/or downlink data that is(are) expected to be transferred between the mobile station 135 and the UTRAN 100. The state transition controller 1115 of the illustrated example then uses the received and decoded information concerning mobile station data activity to make RRC state transition decisions and prepare associated message(s) and message content(s) to send to the mobile station 135 to cause the RRC state transitions. Example implementations and operations of the message decoder 1110 and the state transition controller 1115 are described in greater detail below and in the context of FIGS. 12-17.

As mentioned above, the state transition processor 140 of the mobile station 135 of FIG. 10 and the state configuration processor 145 of the RNC 120 of FIG. 11 implement one or more solutions, or combinations thereof, from one or more families of example solutions disclosed herein for reducing data transfer latency caused by state transitions in mobile networks. For example, in a first family of example solutions disclosed herein, the state transition processor 140 enables the mobile station 135 to provide to the RNC 120 of the UTRAN 100 more data activity information than just an indication of the mobile station's uplink RLC buffer occupancy. In such solutions, instead of being limited to providing just an indication of uplink RLC buffer occupancy, as in prior 3GPP UMTS systems, the state transition processor 140 also determines and signals information to inform the RNC 120 of the UTRAN 100 about large amount(s) of uplink data and/or downlink data that is(are) expected to be transferred, but which may not yet be buffered for transmission. To implement at least some solutions in the first family of example solutions, the state transition processor 140 may also determine and signal information indicating (1) the direction (e.g., downlink, uplink, or both) of the large amount of data that is expected to be transferred, (2) one or more characteristics of the data that is expected to be transferred, etc. Such example solutions may provide useful data activity information to the RNC 120 of the UTRAN 100 sooner than in prior 3GPP-compliant systems, thereby enabling the state configuration processor 145 of the RNC 120 to cause the mobile station 135 to transition to an appropriate RRC state (e.g., the Cell_DCH state 205) more quickly.

For example, in one such implementation of the first family of example solutions, the state transition processor 140 implements the following processing flow bounded by the >>>BEGIN<<< and >>>END<<< delimiters:

>>>BEGIN<<<

| | |
|---|---|
| 1> | if the IE “Cell update cause” is set to “uplink data transmission” and if an |

event triggered traffic volume measurement has been configured:

| | |
|---|---|
| 2> | if the UE 135 has upper layer information about the amount of uplink |

or downlink data expected to follow:

| | |
|---|---|
| 3> | if a large amount of uplink or downlink data is expected to |

follow:

| | |
|---|---|
| 4> | include and set the IE “Traffic volume indicator” to |

TRUE;

NOTE: The amount of data that is considered to be ‘large’ is UE implementation
dependent.

| | |
|---|---|
| 2> | else, if the transport channel traffic volume (TCTV) is larger than the |

threshold in the IE “Reporting threshold” for a traffic volume measurement stored in
the MEASUREMENT_IDENTITY variable and that traffic volume measurement has
“measurement identity” equal to 4, “Traffic volume event identity” equal to “4a”,
“Measurement validity” equal to “all states” or “all states except Cell_DCH”:

| | |
|---|---|
| 3> | include and set the IE “Traffic volume indicator” to TRUE. |

>>>END<<<

In another example implementation of the first family of example solutions, the state transition processor 140 implements the following processing flow bounded by the >>>BEGIN<<< and >>>END<<< delimiters:

>>>BEGIN<<<
For frequency division duplexing (FDD) and 1.28 Mcps time division duplexing
(TDD), the UE 135 in Cell_PCH state shall:

| 1> | if variable H_RNTI is set: | |
|---|---|---|
| | 2> | if the measurement reporting is initiated according to, for example, |

3GPP TS 25.331 subclause 8.5.40 or subclause 8.5.47 or subclause 8.5.56:

| | |
|---|---|
| 3> | set the IE “measurement identity” to “16”; |
| 3> | not set the IE “measured results” or “E-UTRA measured results”; |
| 3> | include the IE “measured results on RACH”; |
| 3> | if an event triggered traffic volume measurement has been configured: |

| | |
|---|---|
| 4> | if the UE 135 has upper layer information about the amount of |

uplink or downlink data expected to follow:

| | |
|---|---|
| 5> | if a large amount of uplink or downlink data is expected |

to follow:

| | |
|---|---|
| 6> | include and set the IE “Traffic volume event |

identity” to “4a”;

NOTE: The amount of data that is considered to be ‘large’ is UE implementation
dependent.

| | |
|---|---|
| 4> | else, if the TCTV is larger than the threshold in the IE |

“Reporting threshold” for a traffic volume measurement stored in the
MEASUREMENT_IDENTITY variable and that traffic volume measurement
has “measurement identity” equal to 4, “Traffic volume event identity” equal
to “4a”, “Measurement validity” equal to “all states” or “all states except
Cell_DCH”:

| | |
|---|---|
| 5> | set the IE “Traffic volume event identity” to “4a”. |

>>>END<<<

The preceding two example process flows include a note stating that the amount of data that is considered to be ‘large’ is UE implementation dependent. Additionally or alternatively, some further criteria could be specified to reduce the amount of flexibility given to the UE implementer when setting the indication. For example, it could be specified that the amount of data that is considered to be large must be greater than the “event 4a” threshold, if one is configured.

Also, in the preceding two example process flows, the text specifies that the “event triggered traffic volume measurement has been configured” in order for the UE to set the TVI. Other approaches may be possible. For example, it could be specified that the UE is permitted to set the TVI even if no event triggered traffic volume measurement has been configured.

In yet another example implementation of the first family of example solutions, the state transition processor 140 implements the following processing flow bounded by the >>>BEGIN<<< and >>>END<<< delimiters:

>>>BEGIN<<<

| | |
|---|---|
| 1> | if the UE 135 has upper layer information about the amount of uplink or |

downlink data expected to follow:

| | |
|---|---|
| 3> | if a large amount of uplink or downlink data is expected to follow: |

| | |
|---|---|
| 4> | set the IE “Large traffic volume expected indicator” to TRUE; |

| | |
|---|---|
| 3> | else: |

| | |
|---|---|
| 4> | set the IE “Large traffic volume expected indicator” to FALSE. |

>>>END<<<

In a further example implementation of the first family of example solutions, the state transition processor 140 implements the following processing flow bounded by the >>>BEGIN<<< and >>>END<<< delimiters:

>>>BEGIN<<<
For FDD and 1.28 Mcps TDD, the UE 135 in Cell_PCH state shall:

| 1> | if variable H_RNTI is set: | |
|---|---|---|
| | 2> | if the measurement reporting is initiated according to subclause 8.5.40 |

or subclause 8.5.47 or subclause 8.5.56:

| | |
|---|---|
| 3> | set the IE “measurement identity” to “16”; |
| 3> | not set the IE “measured results” or “E-UTRA measured |

results”;

| | |
|---|---|
| 3> | include the IE “measured results on RACH”; |
| 3> | if an event triggered traffic volume measurement has been |

configured:

| | |
|---|---|
| 4> | if the TCTV is larger than the threshold in the IE |

“Reporting threshold” for a traffic volume measurement stored in the
MEASUREMENT_IDENTITY variable and that traffic volume
measurement has “measurement identity” equal to 4, “Traffic volume
event identity” equal to “4a”, “Measurement validity” equal to “all
states” or “all states except Cell_DCH”:

| | |
|---|---|
| 5> | set the IE “Traffic volume event identity” to |

| | “4a”. |
|---|---|
| 3> | if the UE has upper layer information about the amount of |

uplink or downlink data expected to follow:

| | |
|---|---|
| 4> | if a large amount of uplink or downlink data is expected |

to follow:

| | |
|---|---|
| 5> | set the IE “Large traffic volume expected |

| indicator” to TRUE; | |
|---|---|
| 4> | else: |

| | |
|---|---|
| 5> | set the IE “Large traffic volume expected |

indicator” to FALSE.

>>>END<<<

In the preceding two examples, a new field (“Large traffic volume expected indicator”) is introduced as a Boolean IE (i.e., meaning it can be set to TRUE or FALSE), which is optional for the UE 135 to include in the measurement report. This means that absence of the IE implies that the UE 135 either does not support the new functionality or does not know, or does not wish to further influence the decision of the network. It would also be possible for the new field to be introduced as an ‘Enumerated(TRUE)’ IE (i.e., meaning that it can only be set to one value, TRUE), which is optional for the UE 135 to include. This means that absence of the IE implies that the UE 135 either does not support the functionality, or does not know the amount of data expected to follow, or does know that the amount of data expected to follow is small. The prior TVI indicator uses the optionally included Enumerated(TRUE) approach.

An example of the “Large traffic volume expected indicator” is illustrated in the following table:

TABLE 4

| | | | |
|---|---|---|---|
| Large traffic volume | OP | Boolean | This IE is set based on |
| expected indicator | | | upper layer information |
| | | | about the data activity |
| | | | expected to follow. |

The optionally included Boolean IE in the preceding two examples and illustrated in the preceding table may have some benefits as it provides the UTRAN 100 with more information to use in its decision process. For example, a UTRAN algorithm could be to put the UE 135 in the Cell_DCH state if and only if TVI is present. Let the new large amount of data expected indicator be referred to in the following as the traffic volume expected indicator, or TVE indicator. If the TVE is two valued (e.g., present or absent) then there are the following options for the combination of the TVI and TFE: (no flags, TVI only, TVE only, TVI and TVE). A UTRAN 100 not supporting TVE could act on TVI as legacy UTRANs do today. Conversely, a UTRAN 100 supporting TVE could move the UE 135 into the Cell_DCH state 205 based on TVE and ignore TVI if it knows the UE 135 supports TVE. However, if it UTRAN 100 does not know whether the UE 135 supports TVE, the UTRAN 100 in this examples moves a UE 135 reporting TVI, but not TVE, to the Cell_DCH state 205 to avoid changing behavior for legacy UEs. As another example, consider the three valued TVE (e.g., absent, TVE=True, TVE=False). The advantage of adding the TVE=False case allows UTRAN 100 to leave the UE 135 in the Cell_FACH 215 state in the case when the TVI, TVE pair indicates (TVI present, TVE=False).

As another example, in a second family of example solutions disclosed herein, the state transition processor 140 enables the mobile station 135 to provide to the RNC 120 of the UTRAN 100 an indication of the mobile station's uplink RLC buffer occupancy in messages other than just CELL UPDATE messages having a cause value set to “uplink data transmission.” For example, instead of being limited to providing the TVI in just the CELL UPDATE message having the cause value of “uplink data transmission,” as in prior 3GPP UMTS systems, the state transition processor 140 also determines and provides the TVI to the RNC 120 of the UTRAN 100 in CELL UPDATE messages having other cause values, or in messages other than CELL UPDATE messages. Like the first family of example solutions, the second family of example solutions may be able to provide useful data activity information to the RNC 120 of the UTRAN 100 sooner than in prior 3GPP-compliant systems, thereby enabling the state configuration processor 145 of the RNC 120 to cause the mobile station 135 to transition to an appropriate RRC state (e.g., the Cell_DCH state 205) more quickly.

For example, in one such implementation of the second family of example solutions, the state transition processor 140 implements the following processing flow bounded by the >>>BEGIN<<< and >>>END<<< delimiters:

>>>BEGIN<<<
The UE 135 shall set the IEs in the CELL UPDATE message as follows:

| | |
|---|---|
| 1> | set the IE “Cell update cause” corresponding to a cause (e.g., as specified in |

3GPP TS 25.331 subclause 8.3.1.2) that is valid when the CELL UPDATE message is
submitted to lower layers for transmission;
NOTE: During the time period starting from when a cell update procedure is initiated
by the UE 135 until when the procedure ends, additional CELL UPDATE messages
may be transmitted by the UE 135 with different causes.

| 1> | if an event triggered traffic volume measurement has been configured: | |
|---|---|---|
| | 2> | if the TCTV is larger than the threshold in the IE “Reporting threshold” |

for a traffic volume measurement stored in the MEASUREMENT_IDENTITY
variable and that traffic volume measurement has “measurement identity” equal to 4,
“Traffic volume event identity” equal to “4a”, “Measurement validity” equal to “all
states” or “all states except Cell_DCH”:

| | |
|---|---|
| 3> | set the IE “Traffic volume indicator” to TRUE. |

| | |
|---|---|
| 2> | else: |

| | |
|---|---|
| 3> | set the IE “Traffic volume indicator” to FALSE. |

>>>END<<<

In another example implementation of the second family of example solutions, the state transition processor 140 implements the following processing flow bounded by the >>>BEGIN<<< and >>>END<<< delimiters:

>>>BEGIN<<<
The UE 135 shall set the IEs in the CELL UPDATE message as follows:

| | |
|---|---|
| 1> | set the IE “Cell update cause” corresponding to a cause (e.g., as specified in |

3GPP TS 25.331 subclause 8.3.1.2) that is valid when the CELL UPDATE message is
submitted to lower layers for transmission;
NOTE: During the time period starting from when a cell update procedure is initiated
by the UE 135 until when the procedure ends, additional CELL UPDATE messages
may be transmitted by the UE 135 with different causes.

| | |
|---|---|
| 1> | if the IE “Cell update cause” is set to “uplink data transmission”, “radio link |

failure”, “cell reselection” or “RLC unrecoverable error”; and

| | |
|---|---|
| 1> | if an event triggered traffic volume measurement has been configured: |

| | |
|---|---|
| 2> | if the TCTV is larger than the threshold in the IE “Reporting |

threshold” for a traffic volume measurement stored in the
MEASUREMENT_IDENTITY variable and that traffic volume measurement
has “measurement identity” equal to 4, “Traffic volume event identity” equal
to “4a”, “Measurement validity” equal to “all states” or “all states except
Cell_DCH”:

| | |
|---|---|
| 3> | set the IE “Traffic volume indicator” to TRUE. |

| | |
|---|---|
| 2> | else: |

| | |
|---|---|
| 3> | set the IE “Traffic volume indicator” to FALSE. |

>>>END<<<

The preceding two examples contain slightly different variants for how the solution is introduced. In the first of the examples, the TVI I is cable of being included in all CELL UPDATE messages (e.g., if the appropriate Traffic Volume Measurement is configured), regardless of the reason for the Cell Update message and setting of the cause value. In the second of the examples, the TVI is capable of being included in CELL UPDATE messages (e.g., if the appropriate Traffic Volume Measurement is configured) when the cell update cause value is one of “radio link failure,” “cell reselection” or “RLC unrecoverable error” (in addition to “UL data transmission”). These additional cases cover at least the race condition scenarios associated with FIGS. 7, 8 and 9 above. Other cause values could be included in the list to cover further race condition scenarios.

In yet another example implementation of the second family of example solutions, the state transition processor 140 implements the following processing flow bounded by the >>>BEGIN<<< and >>>END<<< delimiters:

>>>BEGIN<<<
If the new state is Cell_FACH state, Cell_PCH state or URA_PCH state and if an
event triggered traffic volume measurement has been configured:

| | |
|---|---|
| 1> | if the TCTV is larger than the threshold in the IE “Reporting threshold” for a |

traffic volume measurement stored in the MEASUREMENT_IDENTITY variable
and that traffic volume measurement has “measurement identity” equal to 4, “Traffic
volume event identity” equal to “4a”, “Measurement validity” equal to “all states” or
“all states except Cell_DCH”:

| | |
|---|---|
| 2> | set the IE “Traffic volume indicator” in the response message to |

TRUE.

| 1> | else: | |
|---|---|---|
| | 2> | set the IE “Traffic volume indicator” in the response message to |

FALSE.
>>>END<<<

An example of the “Traffic volume indicator” used in a RADIO BEARER RECONFIGURATION COMPLETE message in accordance with the preceding example is illustrated in the following table:

TABLE 5

| | | | |
|---|---|---|---|
| Traffic volume indicator | OP | Boolean | This IE shall be |
| | | | set to TRUE when |
| | | | the criteria for |
| | | | event based traffic |
| | | | volume |
| | | | measurement |
| | | | reporting is |
| | | | fulfilled. |

The preceding example illustrates modification of only the RADIO BEARER RECONFIGURATION COMPLETE message. Similar changes could additionally or alternatively be made to the RADIO BEARER SETUP COMPLETE message, the RADIO BEARER RELEASE COMPLETE message, the TRANSPORT CHANNEL RECONFIGURATION COMPLETE message, and/or the PHYSICAL CHANNEL RECONFIGURATION COMPLETE message.

As yet another example, in a third family of example solutions disclosed herein, the state transition processor 140 causes the mobile station 135 to reject a message sent from the UTRAN 100 commanding the mobile station 135 to transition from a first RRC state (e.g., the Cell_DCH state 205) to a second RRC state (e.g., the Cell_FACH state 210). For example, the state transition processor 140 may cause the mobile station 135 to reject such a message when the state transition processor 140 determines that uplink data is pending in the mobile station 135. In such examples, the state transition processor 140 may prepare a failure response message to be sent by the mobile station 135 for receipt by the RNC 120 of the UTRAN 100. When the state configuration processor 145 of the RNC 120 receives the failure response, rather than treating the failure response as an indication of a failure requiring remedial action, the state configuration processor 145 instructs the RNC 120 to permit the mobile station 135 to remain in its current RRC state (e.g., the Cell_DCH state 205). This third family of example solutions can help the mobile station 135 avoid at least some of the race conditions described above that may occur when uplink data becomes available in the mobile station 135 after the mobile station 135 has been commanded to change RRC state, but before the mobile station 135 has actually changed RRC state.

For example, in one such implementation of the third family of example solutions, the state transition processor 140 implements the following processing flow bounded by the >>>BEGIN<<< and >>>END<<< delimiters:

>>>BEGIN<<<
If

| | |
|---|---|
| 1> | the reconfiguration message is used to move the UE 135 to Cell_FACH, |

Cell_PCH or URA_PCH state; and

| | |
|---|---|
| 1> | the reconfiguration message includes the IE “Rejection for UL data allowed”; |

and

| | |
|---|---|
| 1> | an event triggered traffic volume measurement has been configured and the |

TCTV is larger than the threshold in the IE “Reporting threshold” for a traffic volume
measurement stored in the MEASUREMENT_IDENTITY variable and that traffic
volume measurement has “measurement identity” equal to 4, “Traffic volume event
identity” equal to “4a”, “Measurement validity” equal to “all states” or “all states
except Cell_DCH”:

| | |
|---|---|
| 2> | transmit a failure response (e.g., as specified in 3GPP TS 25.331 |

subclause 8.2.2.9), setting the information elements as specified below:

| | |
|---|---|
| 3> | include the IE “RRC transaction identifier”; |

| 3> | set it to the value of “RRC transaction identifier” in the entry |
|---|---|
| for the received message in the table “Accepted transactions” in the | |
| variable TRANSACTIONS; | |
| 3> | clear that entry; and |
| 3> | set the IE “failure cause” to “Pending UL Data”. |

| | |
|---|---|
| 2> | set the variable UNSUPPORTED_CONFIGURATION to FALSE; |
| 2> | continue with any ongoing processes and procedures as if the |

reconfiguration message was not received.

| | |
|---|---|
| 2> | the procedure ends. |

>>>END<<<

An example of the “Rejection for UL data allowed” IE used in a RADIO BEARER RECONFIGURATION message in accordance with the preceding example is illustrated in the following table:

TABLE 6

| | | |
|---|---|---|
| Rejection for UL data allowed | OP | Enumerated |
| | | (TRUE) |

An example of the “failure cause” IE used in a RADIO BEARER RECONFIGURATION FAILURE message in accordance with the preceding example is illustrated in the following table:

TABLE 7

| | | | |
|---|---|---|---|
| Failure cause | MP | Enumerated | Four spare values are needed. |
| | | (configuration | |
| | | unsupported, | |
| | | physical | |
| | | channel | |
| | | failure, | |
| | | incompatible | |
| | | simultaneous | |
| | | reconfiguration, | |
| | | protocol | |
| | | error, | |
| | | compressed | |
| | | mode runtime | |
| | | error, cell | |
| | | update | |
| | | occurred, | |
| | | invalid | |
| | | configuration, | |
| | | configuration | |
| | | incomplete, | |
| | | unsupported | |
| | | measurement, | |
| | | MBMS | |
| | | session | |
| | | already | |
| | | received | |
| | | correctly, | |
| | | lower priority | |
| | | MBMS | |
| | | service, | |
| | | Pending UL | |
| | | Data) | |

The preceding example illustrates modification of only the RADIO BEARER RECONFIGURATION and RADIO BEARER RECONFIGURATION FAILURE messages. Similar changes could additionally or alternatively be made to the RADIO BEARER SETUP and RADIO BEARER SETUP FAILURE messages, the RADIO BEARER RELEASE and RADIO BEARER RELEASE FAILURE message, the TRANSPORT CHANNEL RECONFIGURATION and TRANSPORT CHANNEL RECONFIGURATION FAILURE messages, and/or the PHYSICAL CHANNEL RECONFIGURATION and PHYSICAL CHANNEL RECONFIGURATION FAILURE messages.

While example manners of implementing at least portions of the mobile station 135 and RNC 120 of FIG. 1 have been illustrated in FIGS. 10-11, one or more of the elements, processes and/or devices illustrated in FIGS. 10-11 may be combined, divided, re-arranged, omitted, eliminated and/or implemented in any other way. Further, the example state transition processor 140, the example state configuration processor 145, the example message transceiver 1005, the example data transmission evaluator 1010, the example message preparer 1015, the example message transceiver 1105, the example message decoder 1110, the example state transition controller 1115 and/or, more generally, the example mobile station 135 and/or the example RNC 120 of FIGS. 10-11 may be implemented by hardware, software, firmware and/or any combination of hardware, software and/or firmware. Thus, for example, any of the example state transition processor 140, the example state configuration processor 145, the example message transceiver 1005, the example data transmission evaluator 1010, the example message preparer 1015, the example message transceiver 1105, the example message decoder 1110, the example state transition controller 1115 and/or, more generally, the example mobile station 135 and/or the example RNC 120 could be implemented by one or more circuit(s), programmable processor(s), application specific integrated circuit(s) (ASIC(s)), programmable logic device(s) (PLD(s)) and/or field programmable logic device(s) (FPLD(s)), etc. In at least some example implementations, at least one of the example mobile station 135, the example RNC 120, the example state transition processor 140, the example state configuration processor 145, the example message transceiver 1005, the example data transmission evaluator 1010, the example message preparer 1015, the example message transceiver 1105, the example message decoder 1110 and/or the example state transition controller 1115 are hereby expressly defined to include a tangible computer readable medium such as a memory, digital versatile disk (DVD), compact disk (CD), Blu-ray Disc™, etc., storing such software and/or firmware. Further still, the example mobile station 135 and/or the example RNC 120 of FIGS. 10-11 may include one or more elements, processes and/or devices in addition to, or instead of, those illustrated in FIGS. 10-11, and/or may include more than one of any or all of the illustrated elements, processes and devices.

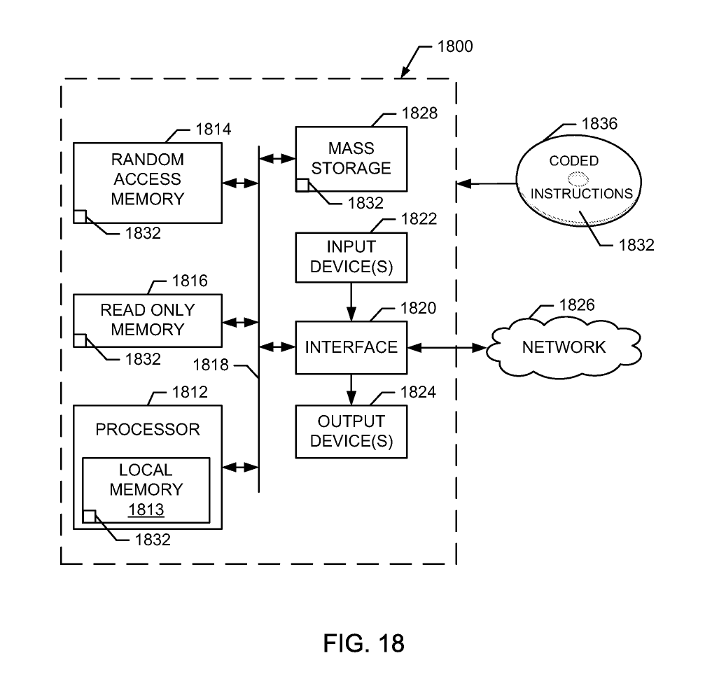

Flowcharts representative of example processes for implementing the example mobile station 135, the example RNC 120, the example state transition processor 140, the example state configuration processor 145, the example message transceiver 1005, the example data transmission evaluator 1010, the example message preparer 1015, the example message transceiver 1105, the example message decoder 1110 and/or the example state transition controller 1115 are shown in FIGS. 12, 12A-D, 13 and 16. In these examples, the process represented by each flowchart may be implemented by one or more programs comprising machine readable instructions for execution by a processor, such as the processor 1812 shown in the example processing system 1800 discussed below in connection with FIG. 18. The one or more programs, or portion(s) thereof, may be embodied in software stored on a tangible computer readable medium such as a CD-ROM, a floppy disk, a hard drive, a digital versatile disk (DVD), a Blu-ray Disc™, or a memory associated with the processor 1812, but the entire program or programs and/or portions thereof could alternatively be executed by a device other than the processor 1812 (e.g., such as a controller and/or any other suitable device) and/or embodied in firmware or dedicated hardware (e.g., implemented by an ASIC, a PLD, an FPLD, discrete logic, etc.). Also, one or more of the processes represented by the flowchart of FIGS. 12, 12A-D, 13 and/or 16, or one or more portion(s) thereof, may be implemented manually. Further, although the example processes are described with reference to the flowcharts illustrated in FIGS. 12, 12A-D, 13 and/or 16, many other methods of implementing the example mobile station 135, the example RNC 120, the example state transition processor 140, the example state configuration processor 145, the example message transceiver 1005, the example data transmission evaluator 1010, the example message preparer 1015, the example message transceiver 1105, the example message decoder 1110 and/or the example state transition controller 1115 may alternatively be used. For example, with reference to the flowcharts illustrated in FIGS. 12, 12A-D, 13 and/or 16, the order of execution of the blocks may be changed, and/or some of the blocks described may be changed, eliminated, combined and/or subdivided into multiple blocks.

As mentioned above, the example processes of FIGS. 12, 12A-D, 13 and/or 16 may be implemented using coded instructions (e.g., computer readable instructions) stored on a tangible computer readable medium such as a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 12, 12A-D, 13 and/or 16 may be implemented using coded instructions (e.g., computer readable instructions) stored on a non-transitory computer readable medium, such as a flash memory, a ROM, a CD, a DVD, a cache, a random-access memory (RAM) and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. Also, as used herein, the terms “computer readable” and “machine readable” are considered equivalent unless indicated otherwise. Furthermore, as used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

A first example process 1200 that may be executed by the example state transition processor 140 of the example mobile station 135 of FIGS. 1 and/or 10 is illustrated in FIG. 12. The first example process 1200 is representative of the first family of example solutions for reducing data transfer latency caused by state transitions in mobile networks described above. As described above, the first family of example solutions enables the mobile station 135 to provide, to the UTRAN 100, more data activity information than just an indication of the mobile station's uplink RLC buffer occupancy. With reference to the preceding figures and associated descriptions, the process 1200 of FIG. 12 begins execution at block 1202 at which the mobile station 135 is operating in a first state (e.g., such as the RRC Cell_FACH state 210, the RRC Cell_PCH state 215, the RRC URA_PCH state 220 or the RRC idle state 225) having fewer available radio resources than would be available in a second state (e.g., such as the RRC Cell_DCH state 205).

Next, at block 1204, the mobile station 135 (e.g., via the data transmission evaluator 1010 of its state transition processor 140) determines whether a large amount of data is expected to be transferred between the mobile station 135 and the UTRAN 100. Example techniques that can be used by the mobile station 135 to determine whether a large amount of data is expected to be transferred are described in greater detail below. If the mobile station 135 determines that a large amount of data is expected to be transferred (block 1206), then processing proceeds to block 1208. At block 1208, the mobile station 135 (e.g., via the message preparer 1015 of its state transition processor 140) sets an indicator to inform the UTRAN 100 that the mobile station 135 has determined a large amount of data is expected to be transferred between the mobile station 135 and the UTRAN 100. At block 1210, the mobile station 135 (e.g., via the message preparer 1015 of its state transition processor 140) sends a message including the indicator to a UTRAN 100.

Although not shown in FIG. 12, in some examples, if the mobile station 135 determines that a large amount of data is not expected to be transferred (block 1206), then processing proceeds in any appropriate manner. For example, if data is expected to be transferred, but at block 1206 the mobile station 135 determines that the amount of data is not large, then the mobile station may send a message (e.g., a CELL UPDATE message) without the indicator of block 1208. In such examples, the absence of this indicator informs the UTRAN 100 that, although the mobile station 135 has determined that data may be transferred, the amount of data expected to be transferred between the mobile station 135 and the UTRAN 100 is not large.

FIG. 12A illustrates a second example process 1220 belonging to the first family of example solutions represented by the example process 1200 of FIG. 12. Accordingly, the process 1220 may be executed by the example state transition processor 140 of the example mobile station 135 of FIGS. 1 and/or 10 to enable the mobile station 135 to provide, to the UTRAN 100, more data activity information than just an indication of the mobile station's uplink RLC buffer occupancy. In particular, the example process 1220 causes the mobile station 135 to send, for example, a CELL UPDATE message to the UTRAN 100 with a TVI value set to TRUE using more information available to the mobile station 135 than just the uplink RLC buffer occupancy. For example, the process 1220 sets the TVI to TRUE when the existing uplink RLC buffer occupancy conditions are satisfied, but can also set the TVI value when the mobile station 135 expects large amounts of uplink and/or downlink data to follow.

A typical use case for the process 1220 may involve a scenario in which the mobile station 135 has uplink data currently buffered in RLC, but the amount of uplink RLC data is insufficient to cause the TVI to be set to TRUE using the prior uplink RLC buffer occupancy conditions. However, due to information available within the mobile station 125 (e.g., such as knowledge from the application layer that it has sent a request for more data, such as via an “HTTP get”), the mobile station 135 expects that a large amount of data (in the uplink and/or downlink) will follow the currently buffered uplink RLC data. Also, in some examples, the mobile station 135 may not have any buffered uplink RLC data, but still has knowledge that a large amount of data (in the uplink and/or downlink) is expected to be transferred. In such examples, the process 1220 causes the TVI to set to inform the UTRAN 100 that large amount(s) of data are expected to be transferred, although the prior uplink RLC buffer occupancy conditions may not be satisfied.

Turning to FIG. 12A, and with reference to the preceding figures and associated descriptions, the example process 1220 includes the processing performed at blocks 1202-1206 of the process 1200 of FIG. 12, which are described above. Then, if at block 1206 the mobile station 135 determines (e.g., via the data transmission evaluator 1010 of its state transition processor 140) that a large amount of data is expected to be transferred, at block 1228 the mobile station 135 (e.g., via the message preparer 1015 of its state transition processor 140) sets the TVI in a CELL UPDATE message to be sent to the UTRAN 100. In some examples, such as in the case of the Enhanced Cell-FACH feature described above in connection with FIG. 5, at block 1228 (i.e., in response to determining that a large amount of data is expected to be transferred) the mobile station 135 (e.g., via the message preparer 1015 of its state transition processor 140) sets the traffic volume event identity in a MEASUREMENT REPORT message (e.g., by setting the value to indicate that a “4a” event has occurred) to be sent to the UTRAN 100. At block 1230, the mobile station 135 sends the CELL UPDATE message containing the TVI (or the MEASUREMENT REPORT message containing the traffic volume event identity) to the UTRAN 100, which informs the UTRAN 100 that one or both of (1) mobile station 135 expects a large amount of data to be transferred and/or (2) the mobile station's uplink RLC data buffer occupancy has exceeded the configured (e.g., the “event 4a”) threshold.

Although not shown in FIG. 12A, in some examples, if the mobile station 135 determines that a large amount of data is not expected to be transferred (block 1206), then processing proceeds in any appropriate manner. For example, the mobile station 135 may send a message (e.g., a CELL UPDATE message) without the TVI of block 1228. Alternatively, the mobile station 135 may send a message with the TVI if, for example, the mobile station's uplink RLC data buffer occupancy has exceeded the configured threshold (although the amount of data expected to be transferred is not large).

A possible benefit of the solution illustrated by the process 1220 is that the existing TVI field in the CELL UPDATE Message is reused. Thus, assuming that existing RNC implementations are likely to choose to move the mobile station 135 to the Cell_DCH state 135 if the TVI is set, the process 1220 could be implemented in the mobile station 135 and experience at least some of the benefits of the change without any change to an existing RNC. Furthermore, in the case that the UTRAN 100 is using the Enhanced Cell_FACH feature, then the mobile station 135 can reuse the “Traffic Volume Event Identity” being set to “4a” in the MEASUREMENT REPORT message sent with Measurement Identity=16 to also indicate that the mobile station 135 expects a large amount of data to be transferred. Note that in some examples, the mobile station's determination that a large amount of data is expected to be transferred is used only for the setting of the TVI in the CELL UPDATE message, only for setting of the ‘Traffic Volume Event Identity’ to “4a” in the MEASUREMENT REPORT sent with Measurement Identity=16, or for setting both indicators.

FIG. 12B illustrates a third example process 1240 belonging to the first family of example solutions represented by the example process 1200 of FIG. 12. Accordingly, the process 1240 may be executed by the example state transition processor 140 of the example mobile station 135 of FIGS. 1 and/or 10 to enable the mobile station 135 to provide, to the UTRAN 100, more data activity information than just an indication of the mobile station's uplink RLC buffer occupancy. In particular, the example process 1240 causes the mobile station 135 to send, for example, a CELL UPDATE message to the UTRAN 100 with a new indicator filed that indicates a large amount of data (uplink and/or downlink) is expected to be transferred, while leaving the use of the existing TVI field unchanged.

Turning to FIG. 12B, and with reference to the preceding figures and associated descriptions, the example process 1240 includes the processing performed at blocks 1202-1206 of the process 1200 of FIG. 12, which are described above. Then, if at block 1206 the mobile station 135 determines (e.g., via the data transmission evaluator 1010 of its state transition processor 140) that a large amount of data is expected to be transferred, at block 1248 the mobile station 135 (e.g., via the message preparer 1015 of its state transition processor 140) sets an indicator, different from the TVI, in a CELL UPDATE message to be sent to the UTRAN 100. In some examples, such as in the case of the Enhanced Cell-FACH feature described above in connection with FIG. 5, at block 1228 (i.e., in response to determining that a large amount of data is expected to be transferred) the mobile station 135 (e.g., via the message preparer 1015 of its state transition processor 140) sets an indicator, different from the traffic volume event identity, in a MEASUREMENT REPORT message to be sent to the UTRAN 100. At block 1250, the mobile station 135 sends the CELL UPDATE message (or the MEASUREMENT REPORT message) containing the new indicator to the UTRAN 100, which informs the UTRAN 100 that the mobile station 135 expects a large amount of data to be transferred.

Although not shown in FIG. 12B, in some examples, if the mobile station 135 determines that a large amount of data is not expected to be transferred (block 1206), then processing proceeds in any appropriate manner. For example, if data is expected to be transferred, but at block 1206 the mobile station 135 determines that the amount of data is not large, then the mobile station may send a message (e.g., a CELL UPDATE message) without the indicator of block 1248. In such examples, the absence of this indicator informs the UTRAN 100 that, although the mobile station 135 has determined that data may be transferred, the amount of data expected to be transferred between the mobile station 135 and the UTRAN 100 is not large.

A possible benefit of using the new indicator field in the process 1240, instead of redefining the rules for setting the existing TVI field in the CELL UPDATE message as in the process 1220, is that both pieces of information would be available to the RNC 120 when making its RRC state decision, if the RNC 120 is upgraded to support the new indicator field. Similarly, in the case when the UTRAN 100 is using the Enhanced Cell_FACH feature, then the rules for setting the existing ‘Traffic Volume Event Identity’ to “4a” in the MEASUREMENT REPORT message sent with Measurement Identity=16 would be unchanged by the process 1240 and, instead the process 1240 would introduce the new indicator field into the MEASUREMENT REPORT message to inform the UTRAN 100 that a large amount of data is expected to be transferred. Note that in some examples, the new field used to indicate that a large amount of data is expected to be transferred may be added to only the CELL UPDATE message, to only the MEASUREMENT REPORT message, or to both messages.

FIG. 12C illustrates a fourth example process 1260 belonging to the first family of example solutions represented by the example process 1200 of FIG. 12. Accordingly, the process 1260 may be executed by the example state transition processor 140 of the example mobile station 135 of FIGS. 1 and/or 10 to enable the mobile station 135 to provide, to the UTRAN 100, more data activity information than just an indication of the mobile station's uplink RLC buffer occupancy. In particular, the example process 1260 causes the mobile station 135 to send, for example, a new indicator field in a CELL UPDATE message (or a MEASUREMENT REPORT message) to the UTRAN 100 to indicate a direction (e.g., uplink, downlink, or both) of a large amount of data expected to be transferred. In some examples, the process 1260 can be used in combination with the example processes 1220 and/or 1240 to inform the UTRAN 100 of (1) a large amount of data that the mobile station 135 expects to be transferred between the mobile station 135 and the UTRAN 100 and (2) the direction of the expected large amount of data. As described in greater detail below, the mobile station 135 can determine the direction of the expected large amount of data based on, for example, information provided by application(s) executing in the upper layers 135_{UL} of the mobile station 135.

Turning to FIG. 12C, and with reference to the preceding figures and associated descriptions, the example process 1260 includes the processing performed at blocks 1202-1206 of the process 1200 of FIG. 12, which are described above. Then, if at block 1206 the mobile station 135 determines (e.g., via the data transmission evaluator 1010 of its state transition processor 140) that a large amount of data is expected to be transferred, at block 1268 the mobile station 135 (e.g., via the message preparer 1015 of its state transition processor 140) sets a first indicator to indicate that a large amount of data is expected to be transferred. For example, the first indicator may correspond to the TVI or traffic volume event identity set in the example process 1220 of FIG. 12A, or the new indicator, which is different from the TVI and the traffic volume event identity, that is set in the example process 1240 of FIG. 12B. At block 1270, the mobile station 135 (e.g., via the message preparer 1015 of its state transition processor 140) sets a second indicator to inform the UTRAN 100 of the direction of the large amount of data that the mobile station 135 expects to be transferred. At block 1272, the mobile station 135 (e.g., via the message preparer 1015 of its state transition processor 140) sends a CELL UPDATE message (or a MEASUREMENT REPORTING message) containing the first and second indicators to the UTRAN 100, which informs the UTRAN 100 that the mobile station 135 expects a large amount of data to be transferred, as well as the direction of the expected data.

Although not shown in FIG. 12C, in some examples, if the mobile station 135 determines that a large amount of data is not expected to be transferred (block 1206), then processing proceeds in any appropriate manner. For example, if data is expected to be transferred, but at block 1206 the mobile station 135 determines that the amount of data is not large, then the mobile station may send a message (e.g., a CELL UPDATE message) without the indicators of block 1268 and 1270. In such examples, the absence of these indicators informs the UTRAN 100 that, although the mobile station 135 has determined that data may be transferred, the amount of data expected to be transferred between the mobile station 135 and the UTRAN 100 is not large.

In some examples, the first and second indicators used by the process 1260 can be combined into a single indicator that is optionally included in the message and, when present in the message, indicates that the mobile station 135 expects a large amount of data to be transferred, with the value of the indicator further specifying the direction of the data. An example definition of such a combined indicator is provided in Table 8.

TABLE 8

| | | | |
|---|---|---|---|
| Large traffic | OP | Enumerated | This IE is set based on upper layer |
| volume expected | | (Downlink, | information about the data activity |
| indicator | | Uplink, | direction expected. |
| | | Both) | |

In some examples, the additional information concerning the direction of the expected large amount of traffic could be used by the UTRAN 100 to provide/configure required radio transmission resources only in the direction indicated by the UE. As a result, more efficient allocation of the radio resources could be possible without unnecessarily over-assigning resources.

FIG. 12D illustrates a fifth example process 1280 belonging to the first family of example solutions represented by the example process 1200 of FIG. 12. Accordingly, the process 1280 may be executed by the example state transition processor 140 of the example mobile station 135 of FIGS. 1 and/or 10 to enable the mobile station 135 to provide, to the UTRAN 100, more data activity information than just an indication of the mobile station's uplink RLC buffer occupancy. In particular, the example process 1280 expands upon the direction indicator of the example process 1260 and causes the mobile station 135 to send, for example, a new indicator field in a CELL UPDATE message (or a MEASUREMENT REPORT message) to the UTRAN 100 to indicate characteristics of a large amount of data expected to be transferred. For example, the new indicator field could be a traffic descriptor implemented by, or mapping to, a data structure providing a set of different criteria describing expected traffic flow. In some examples, the data structure could include one or more of the following variables set to indicate traffic quality of service (QoS) characteristics based on the mobile station information available in higher layers:

a) Real time/Non real time service;

b) Constant bit rate data/variable bit rate data;

c) Average/maximum/minimum data rate;

d) Average packet inter-arrival time;

e) Average packet size;

f) Data protocol used (e.g., TCP/UDP);

g) Other.

Turning to FIG. 12D, and with reference to the preceding figures and associated descriptions, the example process 1280 includes the processing performed at blocks 1202-1206 of the process 1200 of FIG. 12, which are described above. Then, if at block 1206 the mobile station 135 determines (e.g., via the data transmission evaluator 1010 of its state transition processor 140) that a large amount of data is expected to be transferred, at block 1288 the mobile station 135 (e.g., via the message preparer 1015 of its state transition processor 140) sets a traffic descriptor (or other indicator) to specify characteristics, such as one or more the characteristics listed above, of the large amount of data that is expected to be transferred. At block 1290, the mobile station 135 (e.g., via the message preparer 1015 of its state transition processor 140) sends a CELL UPDATE message (or a MEASUREMENT REPORTING message) containing the traffic descriptor to the UTRAN 100, which informs the UTRAN 100 of the characteristics of the large amount of data the mobile station 135 expects to be transferred.

Although not shown in FIG. 12D, in some examples, if the mobile station 135 determines that a large amount of data is not expected to be transferred (block 1206), then processing proceeds in any appropriate manner. For example, if data is expected to be transferred, but at block 1206 the mobile station 135 determines that the amount of data is not large, then the mobile station may send a message (e.g., a CELL UPDATE message) without the indicator of block 1288. In such examples, the absence of this indicator informs the UTRAN 100 that, although the mobile station 135 has determined that data may be transferred, the amount of data expected to be transferred between the mobile station 135 and the UTRAN 100 is not large.

In some examples, the additional information provided by the example process 1280 can enable the UTRAN 100 to make more informed decisions concerning whether to place the mobile station 135 in the Cell_DCH state 205 or the Cell_FACH state 210. Additionally or alternatively, and in the case of UMTS or LTE networks, the information provided by the data descriptor provided by the example process 1280 could allow the network to more accurately predict the expected traffic pattern and provide/configure required radio resources accordingly.

In the example processes of FIGS. 12 and 12A-D described above, the mobile station 135 determines (e.g., via the data transmission evaluator 1010 of its state transition processor 140) whether a large amount of uplink and/or downlink data is expected to be transferred with the UTRAN 100. Such a determination can be made in a number of ways. For example, the mobile station 135 may receive (e.g., at the data transmission evaluator 1010 of its state transition processor 140) an indication from an application executing in the mobile station's upper layers 135UL that the application expects to begin transmitting and/or receiving a large amount of data. For example, an email application may indicate to the lower layers of the mobile station 135 that a large amount of email is about to be downloaded, or a web browser application may indicate to the lower layers that downlink video streaming is about to be started, which correspond to an indication that a large amount of downlink data is expected to be transferred. As another example, an email application may indicate to the lower layers of the mobile station 135 that a large amount of email is about to be sent, which corresponds to an indication that a large amount of uplink data is expected to be transferred. As yet another example, a video conference application may indicate to the lower layer of the mobile station 135 that video streaming is about to begin in both directions, which corresponds to an indication that a large amount of data is expected to be transferred in both the downlink and uplink directions.

Additionally or alternatively, the mobile station 135 may check (e.g., via the data transmission evaluator 1010 of its state transition processor 140) whether an amount of upper layer uplink data (alone or in combination with any buffered RLC data) is greater than a configured threshold, which may be the same as, or different from, the threshold (e.g., the “event 4a” threshold) configured to measure uplink RLC data buffer occupancy. In such examples, this upper layer data threshold may be configured by the UTRAN 100 using, for example, information broadcast within system information or within a MEASUREMENT CONTROL message for traffic volume measurement.

The example process 1200 of FIG. 12 can also be used in an LTE network to provide the eNB with more information available to the mobile station than just the uplink RLC buffer occupancy. For example, a mobile station implementing the process 1200 in an LTE network can indicate to the eNB when it expects large amounts of uplink and/or downlink data to follow. In an example of using the process 1200 in an LTE network, the mobile station may have uplink data buffered in its PDCP/RLC layer, which the mobile station indicates to the eNB with a BSR. Due to knowledge within the mobile station (e.g., such as an indication from the application layer that it has sent a request for more data, such as via an HTTP get) the mobile station expects that a large amount of data in the downlink and/or uplink directions will follow the currently buffered uplink data. However, it may also possible that the mobile station does not have any buffered uplink data, but still has knowledge that a large amount of data in the downlink and/or uplink directions is expected to be transferred.

In the context of an LTE implementation, the process 1200 could cause the mobile station to inform the network that a large amount of uplink and/or downlink data is expected in a number of ways. For example, the process 1200 could cause the mobile station to send such an indication within a new MAC control element within a MAC-PDU. Additionally or alternatively, the process 1200 could cause the mobile station to send such an indication within one or more of the existing “Long BSR,” “Short BSR” or “Truncated BSR” MAC control elements within a MAC-PDU (e.g., which could be achieved by redefining the meaning of one or more of the values of the buffer size field). Additionally or alternatively, the process 1200 could cause the mobile station to send such an indication within a MAC subheader within a MAC-PDU (e.g., which could be achieved by redefining one or more of the existing reserved bits within the subheader). Additionally or alternatively, the process 1200 could cause the mobile station to send such an indication within an RRC message (e.g., which could be achieved using a new RRC messages or using an extension to an existing RRC message, such as the MEASUREMENT REPORT message).

Example event sequence diagrams 1900 and 2000 that are based on the example processes illustrated in FIGS. 12 and 12A-D, and that illustrate example operations performed by the UE 135 and the UTRAN 100 in accordance with the first family of solutions for reducing data transfer latency caused by state transitions in mobile networks, are illustrated in FIGS. 12E-F. The event sequence diagram 1900 of FIG. 12E shows an example sequence of events that may occur when the UE 135 is initially in CELL_PCH state 215 with no user plane data activity, and then user plane data activity needs to be resumed. In the illustrated example, the user plane data is mobile originated, and is originated in the application or upper layers 135_{UL} of the UE 135. Furthermore, in the illustrated example, the UE 135 determines that a large amount of data is not expected to be transferred. For example, the UE 135 may wish to send a “keep alive message” or a “status update message,” both of which are usually small.

Turning to FIG. 12E, and with the foregoing in mind, at event 1901 of the event sequence diagram 1900, the UE 135 is initially in CELL_PCH state 215. (Note that a similar sequence of events could occur in the case that the UE 135 is initially in URA_PCH state 220). Event 1902 corresponds to user plane data activity is resumed. In the illustrated example, this resumption of user plane data activity is due to the upper layers 135_{UL} of the UE 135 requesting the UE access stratum 135_{AS} to send some data. At event 1903, the UE 135 transitions to CELL_FACH state 210.

At event 1904, the UE 135 sends a CELL UPDATE message to the UTRAN 100. In the illustrated example, the CELL UPDATE message contains a cause value that is set to “uplink data transmission.” Furthermore, in the illustrated example, the initial data to send (e.g., as contained in the RLC buffer of the UE 135) is small and less than the threshold for setting the “Traffic Volume Indicator” (TVI). Thus, the TVI is not set. Also, in the illustrated example, the upper layers 135_{UL} of the UE 135 have determined that a large amount of data is not expected to be transferred, so the corresponding “Large traffic volume expected indicator” is also not set.

Based on the lack of setting of the TVI and/or the “Large traffic volume expected indicator” in the CELL UPDATE message, at event 1905, the UTRAN 100 decides that the data transfer is most appropriately handled in CELL_FACH state 210. At event 1906, the UTRAN 100 responds to the CELL UPDATE message with a CELL UPDATE CONFIRM message. The CELL UPDATE CONFIRM message commands the UE 135 to remain in CELL_FACH state 210. At event 1907, the UE 135 responds to the CELL UPDATE CONFIRM message with a UTRAN MOBILITY INFORMATION CONFIRM message. The purpose of the UTRAN MOBILITY INFORMATION CONFIRM message is to act as a layer 3 acknowledgement message and, in some cases, a different type of “Complete” message may be used as the layer 3 acknowledgment. At event 1908, user plane data transfer, in both the uplink and downlink directions, can now takes place in CELL_FACH state 210. In the illustrated example, a relatively small amount of data is transferred and is handled efficiently without the need to allocate resources in CELL_DCH state 205. After the data transfer is completed, the UTRAN 100 can move the UE 135 back to CELL_PCH state 215 (not shown).

The event sequence diagram 2000 of FIG. 12F shows an example sequence of events that may occur when the UE 135 is initially in CELL_PCH 215 state with no user plane data activity, and then user plane data activity needs to be resumed. In the illustrated example, the user plane data is mobile originated, and is originated in the application or upper layers 135_{UL} of the UE 135. Furthermore, in the illustrated example, the UE 135 determines that a large amount of data is expected to be transferred. For example, a browser on the UE 135 may be attempting to access a website, or an email client on the UE 135 may be attempting to send a large email, etc.

Turning to FIG. 12F, and with the foregoing in mind, at event 2001 of the event sequence diagram 2000, the UE 135 is initially in CELL_PCH state 215. (Note that a similar sequence of events could occur in the case that the UE 135 is initially in URA_PCH state 220). Event 2002 corresponds to user plane data activity is resumed. In the illustrated example, this resumption of user plane data activity is due to the upper layers 135_{UL} of the UE 135 requesting the UE access stratum 135_{AS} to send some data. At event 2003, the UE 135 transitions to CELL_FACH state 210.

At event 2004, the UE 135 sends a CELL UPDATE message to the UTRAN 100. In the illustrated example, the CELL UPDATE message contains a cause value that is set to “uplink data transmission.” Furthermore, in the illustrated example, the initial data to send (e.g., as contained in the RLC buffer of the UE 135), is small and less than the threshold for setting the “Traffic Volume Indicator” (TVI). Thus, the TVI is not set. For example, the initial data may be small as it may be just a domain name system (DNS) lookup request or a hypertext transfer protocol (HTTP) get message. However, in the illustrated example, the upper layers 135_{UL} of the UE 135 have determined that a large amount of data is expected to be transferred, so the corresponding “Large traffic volume expected indicator” is set in the CELL UPDATE message.

Based on the setting of the “Large traffic volume expected indicator” in the CELL UPDATE message, at event 2005, the UTRAN decides that the data transfer is most appropriately handled in CELL_DCH state 205 (even though the TVI is not set). At event 2006, the UTRAN 100 sends a CELL UPDATE CONFIRM message that commands the UE 135 to move to CELL_DCH state 205. In some examples, the CELL UPDATE CONFIRM message also configures the UE 135 with an HS-DSCH channel in the DL direction and E-DCH channel in the uplink direction. At event 2007, the UE 135 transitions from CELL_FACH state 210 to CELL_DCH state 205. At event 2008, the UE 135 sends a reconfiguration complete message, such as a RADIO BEARER RECONFIGURATION COMPLETE message. The reconfiguration complete message that is sent at event 2008 depends on what configuration parameters were included the CELL UPDATE CONFIRM message. At event 2009, user plane data transfer, in both the uplink and downlink directions, can now take place using the HSPA resources. In the illustrated example, because the UTRAN 100 used the “Large traffic volume expected indicator” from the CELL UPDATE message in its RRC state decision process, the UTRAN 100 has been able to move the UE 135 into the most appropriate state more quickly than would be the case otherwise (e.g. more quickly than if the example event sequence diagram 300 of FIG. 3 was followed).

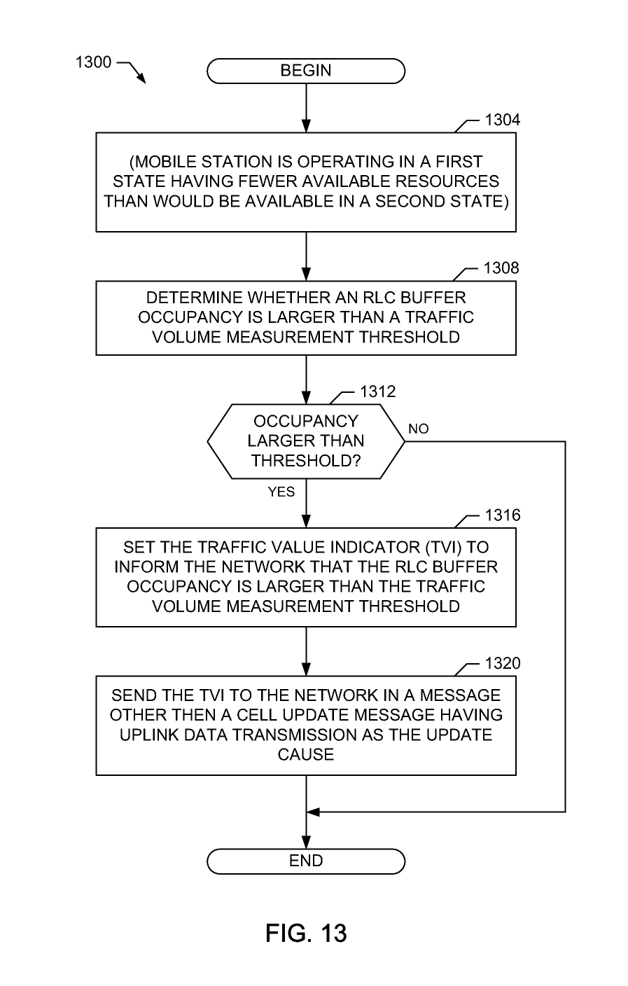

A sixth example process 1300 that may be executed by the example state transition processor 140 of the example mobile station 135 of FIGS. 1 and/or 10 is illustrated in FIG. 13. The sixth example process 1300 is representative of the second family of example solutions for reducing data transfer latency caused by state transitions in mobile networks described above. As described above, the second family of example solutions enables the mobile station 135 to provide to the RNC 120 of the UTRAN 100 an indication of the mobile station's uplink RLC buffer occupancy in messages other than just CELL UPDATE messages having a cause value set to “uplink data transmission.” With reference to the preceding figures and associated descriptions, the process 1300 of FIG. 13 begins execution at block 1304 at which the mobile station 135 is operating in a first state (e.g., such as the RRC Cell_FACH state 210, the RRC Cell_PCH state 215, the RRC URA_PCH state 220 or the RRC idle state 225) having fewer available radio resources than would be available in a second state (e.g., such as the RRC Cell_DCH state 205).

Next, at block 1308, the mobile station 135 (e.g., via the data transmission evaluator 1010 of its state transition processor 140) determines whether the mobile station's uplink RLC data buffer occupancy is greater than a configured traffic volume measurement threshold, such as the “event 4a” threshold. If the mobile station 135 determines that the RLC buffer occupancy is greater than the threshold (block 1312), then processing proceeds to block 1316. At block 1316, the mobile station 135 (e.g., via the message preparer 1015 of its state transition processor 140) sets the traffic volume indicator (TVI) described above to inform the UTRAN 100 that the mobile station's uplink RLC data buffer occupancy is greater than the configured traffic volume measurement threshold. At block 1320, the mobile station 135 (e.g., via the message preparer 1015 of its state transition processor 140) sends the TVI to the UTRAN 100 in a message other than a CELL UPDATE message having a cause value of “uplink data transmission”.

Although not shown in FIG. 13, in some examples, if the mobile station 135 determines that the RLC buffer occupancy is not greater than the threshold (block 1312), then processing proceeds in any appropriate manner. For example, the mobile station 135 may send a message (e.g., a CELL UPDATE message with a cause value of “uplink data transmission” or a message other than a CELL UPDATE message having a cause value of “uplink data transmission”) without the TVI of block 1316.

In some examples, the process 1300 can be used to cause the mobile station 125 to include the TVI (e.g., if the traffic volume criteria are met) in CELL UPDATE messages sent by the mobile station in the race condition scenarios represented by the example event sequence diagrams of FIGS. 7-9. For example, the TVI could be included (e.g., if the traffic volume criteria is met) in CELL UPDATE messages sent by the mobile station 135 under a one or more new criteria to cover one or more of the race scenarios described above. In some examples, these new criteria are in addition to the current specified behavior in which the TVI can only be included in CELL UPDATE messages having cause values of “uplink data transmission,” which can only occur when the mobile station is initially in the CELL-PCH state 215 or the URA-PCH state 220. In some examples, the process 1300 permits the TVI to be included in CELL UPDATE messages having just those cause values illustrated in the examples of FIGS. 7-9, whereas in other examples, the TVI is permitted to be included (e.g., if the traffic volume criteria is met) in all CELL UPDATE messages.

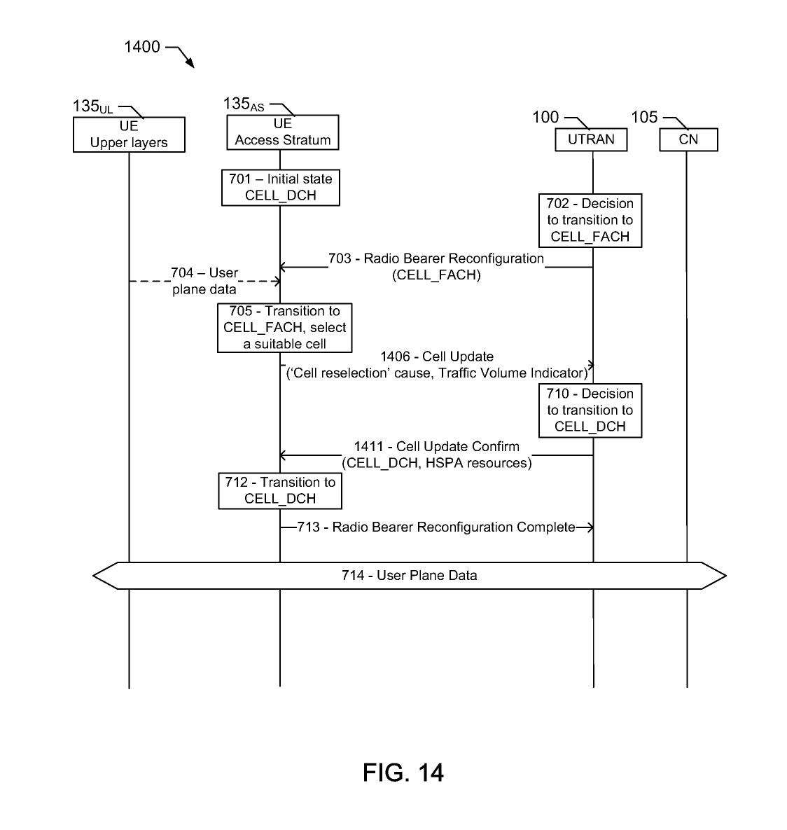

For example, in the case of the race condition represented by the event sequence diagram 700 of FIG. 7, if the CELL UPDATE message that is performed with cause value “cell reselection” could also carry the TVI information element to indicate to the UTRAN 100 that the mobile station 135 has pending uplink data, then the mobile station 135 could have been transferred to the Cell_DCH state 205 by a CELL UPDATE CONFIRM message (see the message at event 1411 of FIG. 14). This means that, in the example of FIG. 7, the transition to the Cell_DCH state 205 could occur more quickly, such as within approximately 1 second in the illustrated example. An example event sequence diagram 1400 corresponding to the sequence 700 of FIG. 7, but with the process 1300 being used to send the TVI in the CELL UPDATE message having the cause value of “cell reselection” at event 1406, is shown in FIG. 14. Like events in FIGS. 7 and 14 are labeled with the same reference numerals. The example process 1300 can be used similarly to reduce state transition times in the example race conditions illustrated in FIGS. 8 and 9.

In some examples, the traffic volume measurement (TVM) thresholds may be different when in the Cell_FACH state 210 than when in the Cell_DCH state 205. In the Cell_FACH state 210, TVM thresholds may be configured in system information (e.g., via system information block SIB12), or could be sent using MEASUREMENT CONTROL messages in the Cell_FACH state 210 or in the Cell_DCH state 205. In some examples, such as after a radio link failure, there might not be an applicable TVM threshold configured for use by the mobile station 135 (such as a TVM threshold corresponding to the configuration TVM ID=4, TYPE=E4a, VALIDITY=(all states or all but DCH)). Alternatively, a TVM threshold may be available, but it is tailored for the Cell_DCH state 205 and, thus, has a large value. In such cases, the mobile station 135 can store the TVM threshold (e.g., the “event 4a threshold”) configured by the UTRAN 100 when the mobile station 135 was operating previously in the Cell_FACH state 210, and then uses this previous threshold in the process 1300 after, for example, recovering from a link failure.

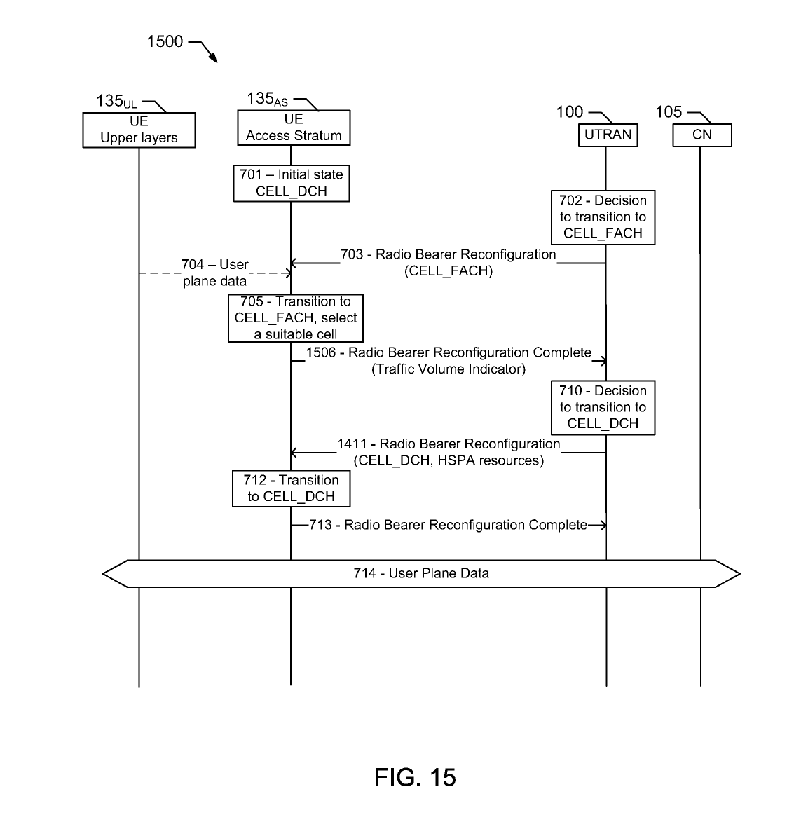

In some examples, the process 1300 can be used to send the TVI to the UTRAN 100 in messages other than the CELL UPDATE message. For example, in the case of the race condition represented by the example log of Table 3, the mobile station 135 can use the process 1300 to send the TVI using a RADIO BEARER RECONFIGURATION COMPLETE message. In such an example, there would be one less uplink message (by elimination of one message over RACH) needed to trigger the transition back to the Cell_DCH state 205. An example event sequence diagram 1500 corresponding to an example scenario in which the process 1300 is used to include the TVI in a message other the CELL UPDATE message, is shown in FIG. 15. The event sequence diagram 1500 is similar to the event sequence diagram, 1400 of FIG. 14, but with the CELL UPDATE message at event 1406 of FIG. 14 being replaced by the RADIO BEARER RECONFIGURATION COMPLETE message at event 1506 of FIG. 15. Like events in FIGS. 14 and 15 are labeled with the same reference numerals.

In the illustrated example of FIG. 15, the UTRAN 100 has used the Radio Bearer Reconfiguration procedure and, thus, the process 1300 is used to include the TVI within the RADIO BEARER RECONFIGURATION COMPLETE message sent at event 1506. In some examples, the process 1300 could be applied to the other reconfiguration procedures and, thus, the TVI could be included in any of the reconfiguration complete messages.

Note that at event 1506, depending on how the UTRAN 100 configured the traffic volume measurement reporting, the transmission of uplink data buffered within RLC may begin while the mobile station 135 is still in the Cell_FACH state 210 (e.g., by using the uplink DTCH on RACH). Alternatively, the transmission may be suspended for a period to allow the UTRAN 100 time to move mobile station 135 to the Cell_DCH state 205, in which case the transmission of uplink data begins at event 714.

In some examples, the process 1300 can be combined with one or more of the processes 1200, 1220, 1240, 1260 and/or 1280. For example, the process 1220 could be used to set the TVI to inform the UTRAN 100 that a large amount of data is expected to be transferred, and the process 1300 could be used to include this TVI in a CELL UPDATE message having a cause value other than “uplink data transmission,” or in a message, such as the RADIO BEARER RECONFIGURATION COMPLETE message, other than a CELL UPDATE message. As another example, the processes 1240, 1260 and/or 1280 could be used to set additional indicators to inform the UTRAN 100 that a large amount of data is expected to be transferred, and the process 1300 could be used to include these indicators in CELL UPDATE messages having cause values other than “uplink data transmission,” or in messages, such as the RADIO BEARER RECONFIGURATION COMPLETE message, other than a CELL UPDATE message.

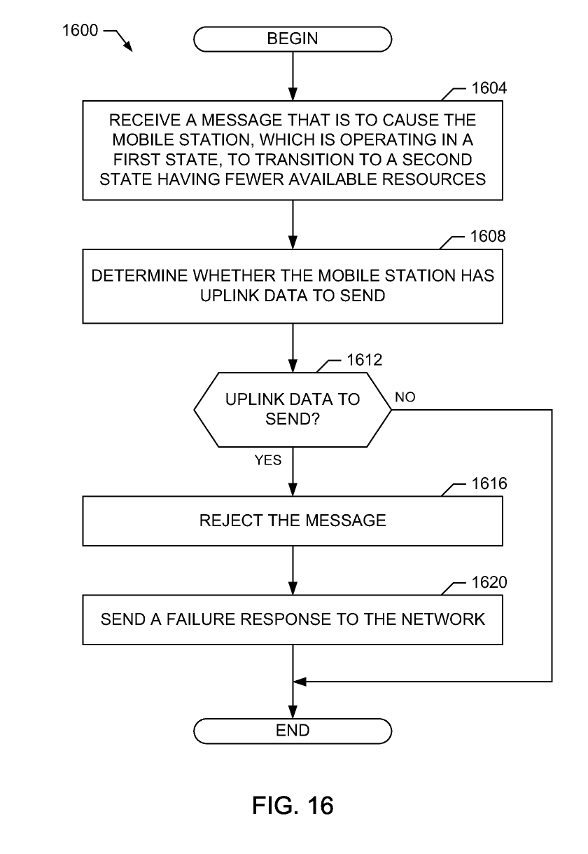

A seventh example process 1600 that may be executed by the example state transition processor 140 of the example mobile station 135 of FIGS. 1 and/or 10 is illustrated in FIG. 16. The seventh example process 1600 is representative of the third family of example solutions for reducing data transfer latency caused by state transitions in mobile networks described above. As described above, the third family of example solutions enables the mobile station 135 to reject a message from the RNC 120 of the UTRAN 100 commanding the mobile station 135 to transition from a first RRC state (e.g., the Cell_DCH state 205) to a second RRC state (e.g., the Cell_FACH state 210) when, for example, the mobile station 135 has pending uplink data to send to the UTRAN 100. With reference to the preceding figures and associated descriptions, the process 1600 of FIG. 16 begins execution at block 1604 at which the message transceiver 1005 of the mobile station 135 receives a message from the UTRAN 100 that is to cause the mobile station 135, which is operating in a first RRC state (e.g., the Cell_DCH state 205) to transition to a second RRC state (e.g., the Cell_FACH state 210).

Next, at block 1608, the mobile station 135 (e.g., via the data transmission evaluator 1010 of its state transition processor 140) determines whether the mobile station 135 has uplink data to be sent to the UTRAN 100. If the mobile station 135 determines that there is pending uplink data to send (block 1612), then processing proceeds to block 1616. At block 1616, the mobile station 135 rejects the message received at block 1604 (e.g., by ignoring the command to transition to the second RRC state). At block 1620, the mobile station 135 (e.g., via the message preparer 1015 of its state transition processor 140) sends a failure response message to inform the UTRAN 100 that the command to transition to the second RRC state has been rejected.

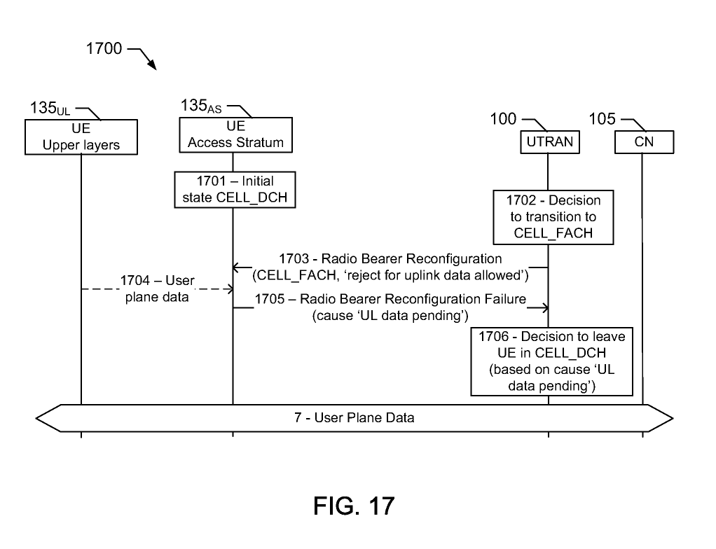

Using the example process 1600, the mobile station 135 can reject a reconfiguration message causing a state transition out of the Cell_DCH state 205. An example event sequence diagram 1700 illustrating this behavior is shown in FIG. 17. In the illustrated example of FIG. 17, the failure response message, or rejection message, sent in response to rejecting the reconfiguration message has a cause value, which may be set to a new value, such as “pending UL data” (see event 1705 of FIG. 17). In some examples, the RNC 120 of the UTRAN 100 responds to this rejection by leaving the mobile station 135 in the Cell_DCH state 205 (see event 1706 of FIG. 17), thereby enabling data transfer to continue uninterrupted. In some examples, the mobile station 135 may decide not to perform the process 1600 when rejection of the Cell_FACH transition does not benefit the mobile station (e.g., such as when the mobile station 135 in the Cell_DCH state 205 has been configured by the UTRAN in a way that currently prevents data from being sent).

In some examples, the UTRAN 100 may not support the process 1600 and, thus, may not expect to receive a reject/failure message in response to a reconfiguration to the Cell_FACH state 210. In such examples, the UTRAN 100 might react by releasing the RRC connection, which is also not desirable. Thus, to avoid such undesirable consequences, the RNC 120 of the UTRAN 100 can include a “flag” or other indicator in the RADIO BEARER RECONFIGURATION message that has the meaning, “if UE has pending uplink data, the UE may reject the Radio Bearer Reconfiguration message,” or a similar meaning. Upon receiving a message with this flag or indicator, and if there is pending uplink data within its uplink RLC data buffer (and/or if one or more of the processes 1200, 1220, 1240, 1260 and/or 1280 corresponding to the first family of solutions described above are implemented and indicate that a large amount of uplink and/or downlink data is expected to follow), the mobile station can transmit a RADIO BEARER RECONFIGURATION FAILURE message (e.g. as described in 3GPP TS 25.331 section 10.2.29) with a Failure Cause (e.g. see 3GPP TS 25.331 section 10.3.3.13) set to “Pending UL data.”

Alternatively, such as in example scenarios in which the UTRAN behavior cannot be modified, if the mobile station and the network equipment vendor behaviors are aligned or compatible, the mobile station 135 can reject the RADIO BEARER RECONFIGURATION message without the need for an explicit flag from the UTRAN that gives permission for the mobile station to reject.

In some examples, the process 1600 of FIG. 16 can be applied by the mobile station 135 to RRC CONNECTION RELEASE messages. In an example use case, the UTRAN 100 sends an RRC CONNECTION RELEASE message at the end of a voice call, but at this point in time there is uplink packet-switched data generated in the mobile station 125. Using the process 1600, the mobile station 135 could respond to the RRC CONNECTION RELEASE message with an RRC CONNECTION RELEASE REJECT message, or similar message, having an “uplink data pending” cause value, or similar cause value. For example, the RRC CONNECTION RELEASE REJECT message does not currently exist in the 3GPP UMTS specification, so an alternative would be to reuse and modify the RADIO BEARER RECONFIGURATION FAILURE message. In vulnerable radio conditions, simultaneous packet switched and circuit switched radio access bearers can lead to an increased call failure rate, which might be mitigated by avoiding packet switched data during a circuit switched call. Thus, the preceding example use case may be of importance as the end of the voice call might commonly coincide with the start of packet switched data activity.

FIG. 18 is a block diagram of an example processing system 1800 capable of executing the processes of FIGS. 12, 12A-D, 13 and/or 16 to implement the example mobile station 135, the example RNC 120, the example state transition processor 140, the example state configuration processor 145, the example message transceiver 1005, the example data transmission evaluator 1010, the example message preparer 1015, the example message transceiver 1105, the example message decoder 1110 and/or the example state transition controller 1115 of FIGS. 1, 10 and/or 11. The processing system 1800 can be, for example, a server, a personal computer, a mobile phone (e.g., a smartphone, a cell phone, etc.), a personal digital assistant (PDA), an Internet appliance, a DVD player, a CD player, a digital video recorder, a Blu-ray player, a gaming console, a personal video recorder, a set top box, a digital camera, or any other type of computing device.

The system 1800 of the instant example includes a processor 1812. For example, the processor 1812 can be implemented by one or more microprocessors and/or controllers from any desired family or manufacturer.

The processor 1812 includes a local memory 1813 (e.g., a cache) and is in communication with a main memory including a volatile memory 1814 and a non-volatile memory 1816 via a bus 1818. The volatile memory 1814 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1816 may be implemented by flash memory and/or any other desired type of memory device. Access to the main memory 1814, 1816 is controlled by a memory controller.

The processing system 1800 also includes an interface circuit 1820. The interface circuit 1820 may be implemented by any type of interface standard, such as an Ethernet interface, a universal serial bus (USB), and/or a PCI express interface.

One or more input devices 1822 are connected to the interface circuit 1820. The input device(s) 1822 permit a user to enter data and commands into the processor 1812. The input device(s) can be implemented by, for example, a keyboard, a mouse, a touchscreen, a track-pad, a trackball, a trackbar (such as an isopoint), a voice recognition system and/or any other human-machine interface.

One or more output devices 1824 are also connected to the interface circuit 1820. The output devices 1824 can be implemented, for example, by display devices (e.g., a liquid crystal display, a cathode ray tube display (CRT)), a printer and/or speakers. The interface circuit 1820, thus, typically includes a graphics driver card.

The interface circuit 1820 also includes a communication device, such as a modem or network interface card, to facilitate exchange of data with external computers via a network 1826 (e.g., an Ethernet connection, a digital subscriber line (DSL), a telephone line, coaxial cable, a cellular telephone system, etc.).

The processing system 1800 also includes one or more mass storage devices 1828 for storing machine readable instructions and data. Examples of such mass storage devices 1828 include floppy disk drives, hard drive disks, compact disk drives and digital versatile disk (DVD) drives.

Coded instructions 1832 corresponding to the instructions of FIGS. 12, 12A-D, 13 and/or 16 may be stored in the mass storage device 1828, in the volatile memory 1814, in the non-volatile memory 1816, in the local memory 1813 and/or on a removable storage medium, such as a CD or DVD 1836.

As an alternative to implementing the methods and/or apparatus described herein in a system such as the processing system of FIG. 18, the methods and or apparatus described herein may be embedded in a structure such as a processor and/or an ASIC (application specific integrated circuit).

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method for a wireless device, the method comprising:
while operating in a first state having fewer available radio resources than would be available in a second state, setting an indicator when a traffic volume measurement threshold has not been exceeded if the wireless device determines that a large amount of data is expected to be transferred; and
sending a message including the indicator to a network.

2. A method as defined in claim 1, wherein the first state comprises at least one of a radio resource control (RRC) Cell_FACH state, an RRC Cell_PCH state, an RRC URA_PCH state or an RRC idle state, and the second state comprises an RRC Cell_DCH state.

3. A method as defined in claim 1, wherein the message comprises a CELL UPDATE message, and the indicator comprises a traffic volume indicator information element (IE) to be included in the CELL UPDATE message.

4. A method as defined in claim 1, wherein the message comprises a CELL UPDATE message, and the indicator comprises an indicator IE, different from a traffic volume indicator IE, to be included in the CELL UPDATE message.

5. A method as defined in claim 1, wherein the message comprises a measurement report, and the indicator comprises a traffic volume event identity IE to be included in the measurement report.

6. A method as defined in claim 1, wherein the message comprises a measurement report, and the indicator comprises an indicator IE, different from a traffic volume event identity IE, to be included in the measurement report.

7. A method as defined in claim 1, further comprising determining that a large amount of data is expected to be transferred based on at least one of (1) determining that an amount of uplink data to be transmitted by the wireless device exceeds a second threshold or (2) receiving an upper layer indication.

8. A method as defined in claim 1, further comprising setting the indicator when the wireless device determines that a large amount of data is expected to be transferred, and a radio link control (RLC) buffer occupancy at the wireless device is not larger than the traffic volume measurement threshold.

9. A method as defined in claim 1, wherein the large amount of data expected to be transferred comprises at least one of uplink data to be transmitted by the wireless device, or downlink data to be received by the wireless device.

10. A method as defined in claim 1, wherein the indicator is a first indicator and further comprising:
setting a second indicator to indicate a transmission direction for the large amount of data expected to be transferred; and
including the first indicator and the second indicator in the message.

11. A method as defined in claim 1, wherein the indicator includes characteristics of the large amount of data expected to be transferred.

12. A method for a wireless device, the method comprising:
while operating in an evolved universal terrestrial radio access network (E-UTRAN) and in a first state having fewer available radio resources than would be available in a second state, setting a first indicator if the wireless device determines that a large amount of data is expected to be transferred, the first indicator to be included in a buffer status report (BSR), the first indicator being different from a second indicator to be included in the BSR, the second indicator to indicate uplink RLC buffer occupancy at the wireless device; and
sending the BSR.

13. A tangible machine readable medium comprising machine readable instructions which, when executed, cause a machine to at least:
while a wireless device is operating in a first state having fewer available radio resources than would be available in a second state, set an indicator when a traffic volume measurement threshold has not been exceeded if the machine determines that a large amount of data is expected to be transferred; and
send a message including the indicator to a network.

14. (canceled)

15. A tangible machine readable medium as defined in claim 13, wherein the message comprises a CELL UPDATE message, and the indicator comprises a traffic volume indicator information element (IE) to be included in the CELL UPDATE message.

16. A tangible machine readable medium as defined in claim 13, wherein the message comprises a CELL UPDATE message, and the indicator comprises an indicator IE, different from a traffic volume indicator IE, to be included in the CELL UPDATE message.

17-24. (canceled)

25. A wireless device comprising:
a memory to store machine readable instructions; and
a processor configured to:
while the wireless device is operating in a first state having fewer available radio resources than would be available in a second state, set an indicator when a traffic volume measurement threshold has not been exceeded if the processor determines that a large amount of data is expected to be transferred; and
send a message including the indicator to a network.

26. (canceled)

27. A wireless device as defined in claim 25, wherein the message comprises a CELL UPDATE message, and the indicator comprises a traffic volume indicator information element (IE) to be included in the CELL UPDATE message.

28. A wireless device as defined in claim 25, wherein the message comprises a CELL UPDATE message, and the indicator comprises an indicator IE, different from a traffic volume indicator IE, to be included in the CELL UPDATE message.

29. A wireless device as defined in claim 25, wherein the message comprises a measurement report, and the indicator comprises a traffic volume event identity IE to be included in the measurement report.

30. A wireless device as defined in claim 25, wherein the message comprises a measurement report, and the indicator comprises an indicator IE, different from a traffic volume event identity IE, to be included in the measurement report.

31-36. (canceled)
